(19) United States
(12) Patent Application Publication
(10) Pub. No.: US 2018/0357067 A1
(43) Pub. Date: Dec. 13, 2018

(54) IN-BAND HARDWARE RESET FOR VIRTUAL GENERAL PURPOSE INPUT/OUTPUT INTERFACE

(71) Applicant: QUALCOMM Incorporated, San Diego, CA (US)

(72) Inventors: Lalan Jee MISHRA, San Diego, CA (US); Richard Dominic WIETFELDT, San Diego, CA (US)

(21) Appl. No.: 15/994,955

(22) Filed: May 31, 2018

Related U.S. Application Data
(60) Provisional application No. 62/517,772, filed on Jun. 9, 2017.

(51) Int. Cl. G06F 9/4401; G06F 1/10

(52) U.S. Cl. CPC G06F 9/4403; G06F 1/10

(57) ABSTRACT

Systems, methods, and apparatus for signaling in-band hardware resets over a serial communication link are provided. A sending device obtains a reference value for configuring a pulse to be sent to the receiving device, configures the pulse to have a logic state (low logic state or high logic state) for a time period based on the reference value, and sends the pulse on a data line between the sending device and a receiving device to indicate the in-band hardware reset to the receiving device. A receiving device receives a pulse on a data line between a sending device and the receiving device, compares a time period of a logic state (low logic state or high logic state) of the pulse to a reference value, detects whether the pulse indicates the in-band hardware reset based on comparison, and performs the in-band hardware reset if the pulse indicates the hardware reset.

### CROSS-REFERENCE TO RELATED APPLICATIONS

This application claims priority to and the benefit of U.S. Provisional Patent Application No. 62/517,772, filed on Jun. 9, 2017, titled “IN-BAND HARDWARE RESET FOR VIRTUAL GENERAL PURPOSE INPUT/OUTPUT INTERFACE”, the entire contents of which is incorporated herein by reference.

### TECHNICAL FIELD

The present disclosure relates generally to serial communication and, more particularly, to signaling in-band hardware resets over a serial communication link

### BACKGROUND

Mobile communication devices may include a variety of components including circuit boards, integrated circuit (IC) devices and/or System-on-Chip (SoC) devices. The components may include processing devices, user interface components, storage and other peripheral components that communicate through a shared data communication bus, which may include a serial bus or a parallel bus. General-purpose serial interfaces known in the industry include the Inter-Integrated Circuit (I2C or I²C) serial bus and its derivatives and alternatives, including interfaces defined by the Mobile Industry Processor Interface (MIPI) Alliance, such as I3C and the Radio Frequency Front-End (RFFE) interface.

In one example, the I2C serial bus is a serial single-ended computer bus that was intended for use in connecting low-speed peripherals to a processor. Some interfaces provide multi-master buses in which two or more devices can serve as a bus master for different messages transmitted on the serial bus. In another example, the RFFE interface defines a communication interface for controlling various radio frequency (RF) front-end devices, including power amplifier (PA), low-noise amplifiers (LNAs), antenna tuners, filters, sensors, power management devices, switches, etc. These devices may be collocated in a single IC device or provided in multiple IC devices. In a mobile communications device, multiple antennas and radio transceivers may support multiple concurrent RF links

General purpose input/output (GPIO) enables an integrated circuit designer to provide generic pins that may be customized for particular applications. For example, a GPIO pin is programmable to be either an output or an input pin depending upon a user's needs. A GPIO module or peripheral will typically control groups of pins which can vary based on the interface requirement. Because of the programmability of GPIO pins, they are commonly included in microprocessor and microcontroller applications. For example, an applications processor in mobile devices may use a number of GPIO pins to conduct handshake signaling such as inter-processor communication (IPC) with a modem processor.

In many instances, a number of command and control signals are employed to connect different component devices in mobile communication devices. These connections consume precious general-purpose input/output (GPIO) pins within the mobile communication devices and it would be desirable to replace the physical interconnects with signals carried in information transmitted over existing serial data links

As mobile communication devices continue to include a greater level of functionality, improved serial communication techniques are needed to support a variety of transmissions over existing serial data links between peripherals and application processors.

### SUMMARY

Certain aspects of the disclosure relate to systems, apparatus, methods and techniques that can communicate in-band hardware resets over a data line between a host and slave.

In various aspects of the disclosure, a method performed at a sending device for signaling an in-band hardware reset to a receiving device, includes obtaining a reference value for configuring a pulse to be sent to the receiving device, configuring the pulse to have a logic state (low logic state or high logic state) for a time period based on the reference value, and sending the pulse on a data line between the sending device and the receiving device to indicate the in-band hardware reset to the receiving device.

In an aspect, the pulse is sent to the receiving device a consecutive number of times to indicate the in-band hardware reset. Accordingly, the method may further include negotiating with the receiving device the number of times the pulse is to be consecutively sent to indicate the in-band hardware reset.

In an aspect, the reference value may be an ideal maximum time period for the pulse to have the logic state, and the pulse may be configured to have the logic state for the time period that is greater than the ideal maximum time period. In another aspect, the reference value may be an ideal minimum time period for the pulse to have the logic state, and the pulse may be configured to have the logic state for the time period that is less than the ideal minimum time period. In a further aspect, the reference value may be a maximum number of clock cycles for a maximum length valid datagram, and the pulse may be configured to have the logic state for the time period equivalent to a number of clock cycles greater than the maximum number of clock cycles for the maximum length valid datagram. In yet another aspect, the reference value may be a maximum length of a valid datagram, and the pulse may be configured to have the logic state for the time period that is greater than the maximum length of the valid datagram.

In various aspects of the disclosure, a sending device for signaling an in-band hardware reset to a receiving device, includes a line interface and a processing circuit. The processing circuit is configured to obtain a reference value for configuring a pulse to be sent to the receiving device, configure the pulse to have a logic state (low logic state or high logic state) for a time period based on the reference value, and send the pulse on a data line between the sending device and the receiving device via the line interface to indicate the in-band hardware reset to the receiving device.

In various aspects of the disclosure, a sending device for signaling an in-band hardware reset to a receiving device, includes means for obtaining a reference value for configuring a pulse to be sent to the receiving device, means for configuring the pulse to have a logic state (low logic state or high logic state) for a time period based on the reference value, and means for sending the pulse on a data line between the sending device and the receiving device to indicate the in-band hardware reset to the receiving device.

In various aspects of the disclosure, a processor-readable storage medium having one or more instructions which, when executed by at least one processor of a processing circuit, cause the processing circuit to obtain a reference value for configuring a pulse to be sent to a receiving device, configure the pulse to have a logic state (low logic state or high logic state) for a time period based on the reference value, and send the pulse on a data line between a sending device and the receiving device to indicate an in-band hardware reset to the receiving device.

In various aspects of the disclosure, a method performed at a receiving device for detecting an in-band hardware reset from a sending device, includes receiving a pulse on a data line between the sending device and the receiving device, comparing a time period of a logic state (low logic state or high logic state) of the pulse to a reference value, detecting whether the pulse indicates the in-band hardware reset based on the comparison, and performing the in-band hardware reset if the pulse indicates the in-band hardware reset.

In an aspect, the detecting whether the pulse indicates the in-band hardware reset may be further based on a consecutive number of times the pulse is received. Accordingly, the method may further include negotiating with the sending device the number of times the pulse is to be consecutively received to detect whether the pulse indicates the in-band hardware reset.

In an aspect, the reference value may be an ideal maximum time period for the pulse to have the logic state, and the pulse may be detected to indicate the in-band hardware reset if the time period of the logic state of the pulse is greater than the ideal maximum time period. In another aspect, the reference value may be an ideal minimum time period for the pulse to have the logic state, and the pulse may be detected to indicate the in-band hardware reset if the time period of the logic state of the pulse is less than the ideal minimum time period. In a further aspect, the reference value may be a maximum number of clock cycles for a maximum length valid datagram, and the pulse may be detected to indicate the in-band hardware reset if the time period of the logic state of the pulse is equivalent to a number of clock cycles greater than the maximum number of clock cycles for the maximum length valid datagram. In yet a further aspect, the reference value may be a maximum length of a valid datagram, and the pulse may be detected to indicate the in-band hardware reset if the time period of the logic state of the pulse is greater than the maximum length of the valid datagram.

In various aspects of the disclosure, a receiving device for detecting an in-band hardware reset from a sending device, includes a line interface and a processing circuit. The processing circuit is configured to receive a pulse on a data line between the sending device and the receiving device via the line interface, compare a time period of a logic state (low logic state or high logic state) of the pulse to a reference value, detect whether the pulse indicates the in-band hardware reset based on the comparison, and perform the in-band hardware reset if the pulse indicates the in-band hardware reset.

In various aspects of the disclosure, a receiving device for detecting an in-band hardware reset from a sending device, includes means for receiving a pulse on a data line between the sending device and the receiving device, means for comparing a time period of a logic state (low logic state or high logic state) of the pulse to a reference value, means for detecting whether the pulse indicates the in-band hardware reset based on the comparison, and means for performing the in-band hardware reset if the pulse indicates the in-band hardware reset.

In various aspects of the disclosure, a processor-readable storage medium having one or more instructions which, when executed by at least one processor of a processing circuit, cause the processing circuit to receive a pulse on a data line between a sending device and a receiving device, compare a time period of a logic state (low logic state or high logic state) of the pulse to a reference value, detect whether the pulse indicates an in-band hardware reset based on the comparison, and perform the in-band hardware reset if the pulse indicates the hardware reset.

### BRIEF DESCRIPTION OF THE DRAWINGS

FIG. 1 illustrates an apparatus employing a data link between IC devices that is selectively operated according to one of plurality of available standards.

FIG. 2 illustrates a system architecture for an apparatus employing a data link between IC devices.

FIG. 3 illustrates a device that employs an RFFE bus to couple various radio frequency front-end devices.

FIG. 4 illustrates a device that employs an I3C bus to couple various front-end devices in accordance with certain aspects disclosed herein.

FIG. 5 illustrates an apparatus that includes an Application Processor and multiple peripheral devices that may be adapted according to certain aspects disclosed herein.

FIG. 6 illustrates an apparatus that has been adapted to support Virtual GPIO in accordance with certain aspects disclosed herein.

FIG. 7 illustrates examples of VGI broadcast frames according to certain aspects disclosed herein.

FIG. 8 illustrates examples of VGI directed frames according to certain aspects disclosed herein.

FIG. 9 illustrates configuration registers that may be associated with a physical pin according to certain aspects disclosed herein.

FIG. 10 is a diagram illustrating example VGI implementations according to certain aspects disclosed herein.

FIG. 11 illustrates a VGI point-to-point configuration that does not support in-band hardware reset.

FIG. 12 illustrates a VGI point-to-point configuration that supports in-band hardware reset.

FIG. 13 illustrates a technique for implementing in-band hardware reset with VGI with respect to a pulse width modulation (PWM)/phase modulated pulse width modulation (PM-PWM) signaling mode.

FIG. 14 illustrates another technique for implementing in-band hardware reset with VGI with respect to a pulse width modulation (PWM)/phase modulated pulse width modulation (PM-PWM) signaling mode.

FIG. 15 illustrates a technique for implementing in-band hardware reset with VGI with respect to a synchronous UART signaling mode.

FIG. 16 illustrates a technique for implementing in-band hardware reset with VGI with respect to an asynchronous UART signaling mode.

FIG. 17 illustrates a method for receiving in-band hardware reset signaling according to certain aspects disclosed herein.

FIG. 18 is a first flowchart illustrating certain operations of an application processor adapted in accordance with certain aspects disclosed herein.

FIG. 19 illustrates a first example of a hardware implementation for an apparatus adapted in accordance with certain aspects disclosed herein.

FIG. 20 is a second flowchart illustrating certain operations of an application processor adapted in accordance with certain aspects disclosed herein.

FIG. 21 illustrates a second example of a hardware implementation for an apparatus adapted in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

### Overview

Devices that include multiple SoC and other IC devices often employ a shared communication interface that may include a serial bus or other data communication link to connect processors with modems and other peripherals. The serial bus or other data communication link may be operated in accordance with multiple standards or protocols defined. In one example, a serial bus may be operated in accordance with I2C, I3C, and/or RFFE, protocols. According to certain aspects disclosed herein, GPIO pins and signals may be virtualized into GPIO state information that may be transmitted over a data communication link Virtualized GPIO state information may be transmitted over a variety of communication links, including links that include wired and wireless communication links For example, virtualized GPIO state information can be packetized or otherwise formatted for transmission over wireless networks including Bluetooth, Wireless LAN, cellular networks, etc. Examples involving wired communication links are described herein to facilitate understanding of certain aspects.

Certain aspects disclosed herein provide methods, circuits, and systems that are adapted to signal in-band hardware resets over a serial communication link A device is enabled to configure a pulse to have a low logic state for a time period based on a reference value, and send the configured pulse on a data line to a receiving device to indicate the hardware reset. As such, the need for a separate hard reset line for indicating the hardware reset between devices is eliminated, and a package size may be decreased.

Examples of Apparatus that Employ Serial Data Links

According to certain aspects, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similar functioning device.

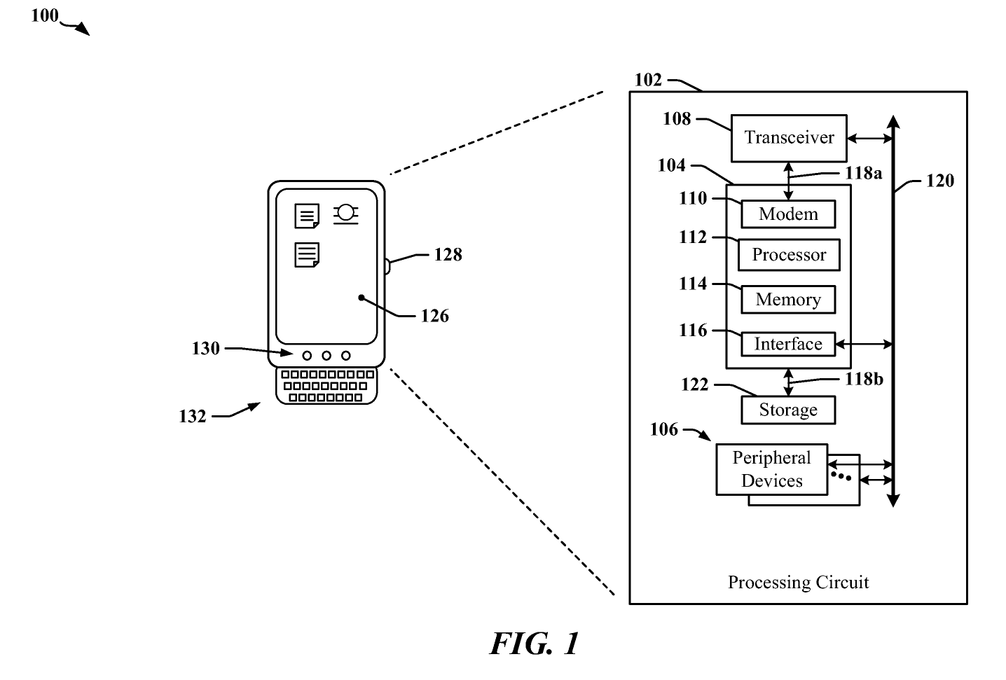

FIG. 1 illustrates an example of an apparatus 100 that may employ a data communication bus. The apparatus 100 may include a processing circuit 102 having multiple circuits or devices 104, 106, and/or 108, which may be implemented in one or more application-specific integrated circuits (ASICs) or in a SoC. In one example, the apparatus 100 may be a communication device and the processing circuit 102 may include a processing device provided in an ASIC 104, one or more peripheral devices 106, and a transceiver 108 that enables the apparatus to communicate with a radio access network, a core access network, the Internet, and/or another network.

The ASIC 104 may have one or more processors 112, one or more modems 110, on-board memory 114, a bus interface circuit 116, and/or other logic circuits or functions. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as a display 126, operator controls, such as switches or buttons 128, 130, and/or an integrated or external keypad 132, among other components. A user interface module may be configured to operate with the display 126, keypad 132, etc. through a dedicated communication link or through one or more serial data interconnects.

The processing circuit 102 may provide one or more buses 118a, 118b, 120 that enable certain devices 104, 106, and/or 108 to communicate. In one example, the ASIC 104 may include a bus interface circuit 116 that includes a combination of circuits, counters, timers, control logic, and other configurable circuits or modules. In one example, the bus interface circuit 116 may be configured to operate in accordance with communication specifications or protocols. The processing circuit 102 may include or control a power management function that configures and manages the operation of the apparatus 100.

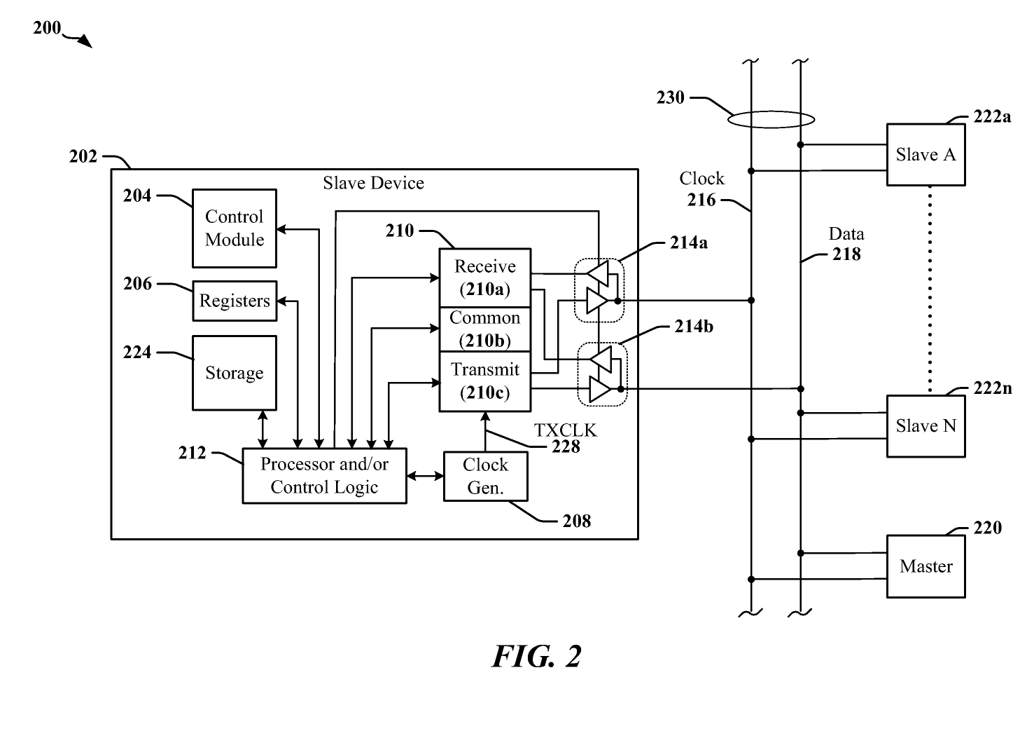

FIG. 2 illustrates certain aspects of an apparatus 200 that includes multiple devices 202, 220, and 222a-222n connected to a serial bus 230. The devices 202, 220, and 222a-222n may include one or more semiconductor IC devices, such as an applications processor, SoC or ASIC. Each of the devices 202, 220, and 222a-222n may include, support or operate as a modem, a signal processing device, a display driver, a camera, a user interface, a sensor, a sensor controller, a media player, a transceiver, and/or other such components or devices. Communications between devices 202, 220, and 222a-222n over the serial bus 230 are controlled by a bus master 220. Certain types of bus can support multiple bus masters 220.

The apparatus 200 may include multiple devices 202, 220, and 222a-222n that communicate when the serial bus 230 is operated in accordance with I2C, I3C, or other protocols. At least one device 202, 222a-222n may be configured to operate as a slave device on the serial bus 230. In one example, a slave device 202 may be adapted to provide a control function 204. In some examples, the control function 204 may include circuits and modules that support a display, an image sensor, and/or circuits and modules that control and communicate with one or more sensors that measure environmental conditions. The slave device 202 may include configuration registers 206 or other storage 224, control logic 212, a transceiver 210 and line drivers/receivers 214a and 214b. The control logic 212 may include a processing circuit such as a state machine, sequencer, signal processor, or general-purpose processor. The transceiver 210 may include a receiver 210a, a transmitter 210c, and common circuits 210b, including timing, logic, and storage circuits and/or devices. In one example, the transmitter 210c encodes and transmits data based on timing in one or more signals 228 provided by a clock generation circuit 208.

Two or more of the devices 202, 220, and/or 222a-222n may be adapted according to certain aspects and features disclosed herein to support a plurality of different communication protocols over a common bus, which may include an I2C, and/or I3C protocol. In some instances, devices that communicate using the I2C protocol can coexist on the same 2-wire interface with devices that communicate using I3C protocols. In one example, the I3C protocols may support a mode of operation that provides a data rate between 6 megabits per second (Mbps) and 16 Mbps with one or more optional high-data-rate (HDR) modes of operation that provide higher performance The I2C protocols may conform to de facto I2C standards providing for data rates that may range between 100 kilobits per second (kbps) and 3.2 megabits per second (Mbps). I2C and I3C protocols may define electrical and timing aspects for signals transmitted on the 2-wire serial bus 230, in addition to data formats and aspects of bus control. In some aspects, the I2C and I3C protocols may define direct current (DC) characteristics affecting certain signal levels associated with the serial bus 230, and/or alternating current (AC) characteristics affecting certain timing aspects of signals transmitted on the serial bus 230. In some examples, a 2-wire serial bus 230 transmits data on a first wire 218 and a clock signal on a second wire 216. In some instances, data may be encoded in the signaling state, or transitions in signaling state of the first wire 218 and the second wire 216.

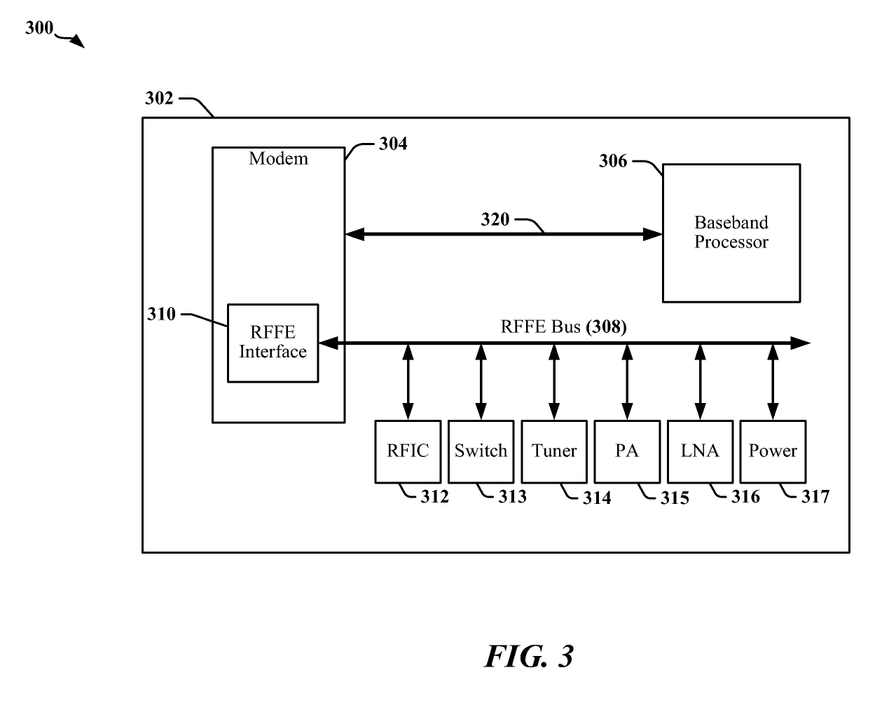

FIG. 3 is a block diagram 300 illustrating an example of a device 302 that employs an RFFE bus 308 to couple various front-end devices 312-317. A modem 304 may include an RFFE interface 310 that couples the modem 304 to the RFFE bus 308. The modem 304 may communicate with a baseband processor 306. The illustrated device 302 may be embodied in one or more of a mobile communication device, a mobile telephone, a mobile computing system, a mobile telephone, a notebook computer, a tablet computing device, a media player, a gaming device, a wearable computing and/or communications device, an appliance, or the like. In various examples, the device 302 may be implemented with one or more baseband processors 306, modems 304, multiple communications links 308, 320, and various other buses, devices and/or different functionalities. In the example illustrated in FIG. 3, the RFFE bus 308 may be coupled to an RF integrated circuit (RFIC) 312, which may include one or more controllers, and/or processors that configure and control certain aspects of the RF front-end. The RFFE bus 308 may couple the RFIC 312 to a switch 313, an RF tuner 314, a power amplifier (PA) 315, a low noise amplifier (LNA) 316 and a power management module 317.

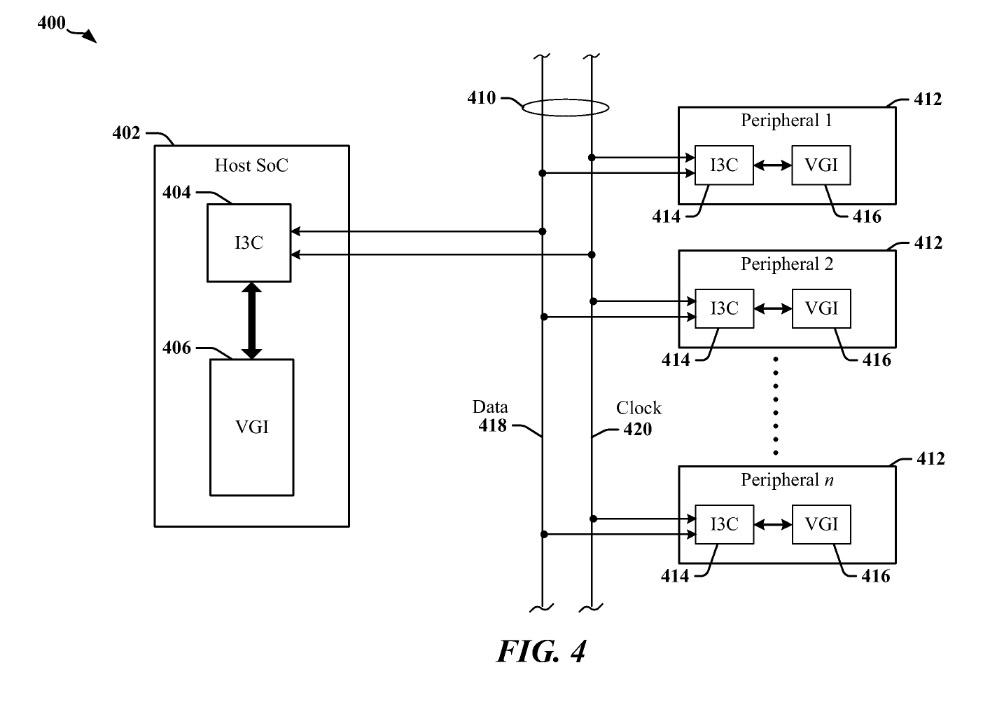

FIG. 4 illustrates an example of an apparatus 400 that uses an I3C bus to couple various devices including a host SoC 402 and a number of peripheral devices 412. The host SoC 402 may include a virtual GPIO finite state machine (VGI FSM 406) and an I3C interface 404, where the I3C interface 404 cooperates with corresponding I3C interfaces 414 in the peripheral devices 412 to provide a communication link between the host SoC 402 and the peripheral devices 412. Each peripheral device 412 includes a VGI FSM 416. In the illustrated example, communications between the SoC 402 and a peripheral device 412 may be serialized and transmitted over a multi-wire serial bus 410 in accordance with an I3C protocol. In other examples, the host SoC 402 may include other types of interface, including I2C and/or RFFE interfaces. In other examples, the host SoC 402 may include a configurable interface that may be employed to communicate using I2C, I3C, RFFE and/or another suitable protocol. In some examples, a multi-wire serial bus 410, such as an I2C or I3C bus, may transmit a data signal over a data wire 418 and a clock signal over a clock wire 420.

### Signaling Virtual GPIO Configuration Information

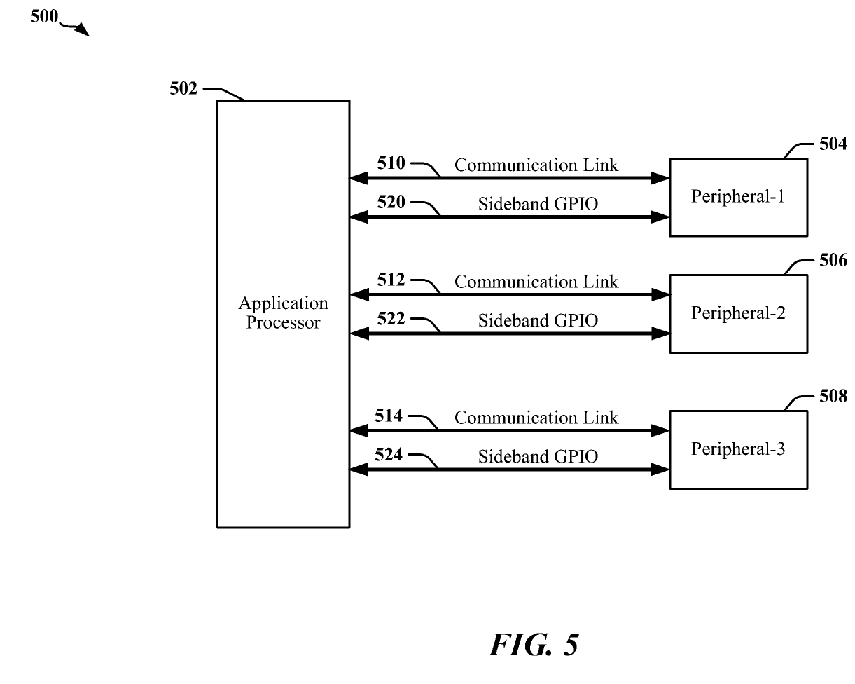

Mobile communication devices, and other devices that are related or connected to mobile communication devices, increasingly provide greater capabilities, performance and functionalities. In many instances, a mobile communication device incorporates multiple IC devices that are connected using a variety of communications links FIG. 5 illustrates an apparatus 500 that includes an Application Processor 502 and multiple peripheral devices 504, 506, 508. In the example, each peripheral device 504, 506, 508 communicates with the Application Processor 502 over a respective communication link 510, 512, 514 operated in accordance with mutually different protocols. Communication between the Application Processor 502 and each peripheral device 504, 506, 508 may involve additional wires that carry control or command signals between the Application Processor 502 and the peripheral devices 504, 506, 508. These additional wires may be referred to as sideband general purpose input/output (sideband GPIO 520, 522, 524), and in some instances the number of connections needed for sideband GPIO 520, 522, 524 can exceed the number of connections used for a communication link 510, 512, 514.

GPIO provides generic pins/connections that may be customized for particular applications. For example, a GPIO pin may be programmable to function as an output, input pin or a bidirectional pin, in accordance with application needs. In one example, the Application Processor 502 may assign and/or configure a number of GPIO pins to conduct handshake signaling or inter-processor communication (IPC) with a peripheral device 504, 506, 508 such as a modem. When handshake signaling is used, sideband signaling may be symmetric, where signaling is transmitted and received by the Application Processor 502 and a peripheral device 504, 506, 508. With increased device complexity, the increased number of GPIO pins used for IPC communication may significantly increase manufacturing cost and limit GPIO availability for other system-level peripheral interfaces.

According to certain aspects, the state of GPIO, including GPIO associated with a communication link, may be captured, serialized and transmitted over a data communication link In one example, captured GPIO may be transmitted in packets over an I3C bus using common command codes to indicate packet content and/or destination.

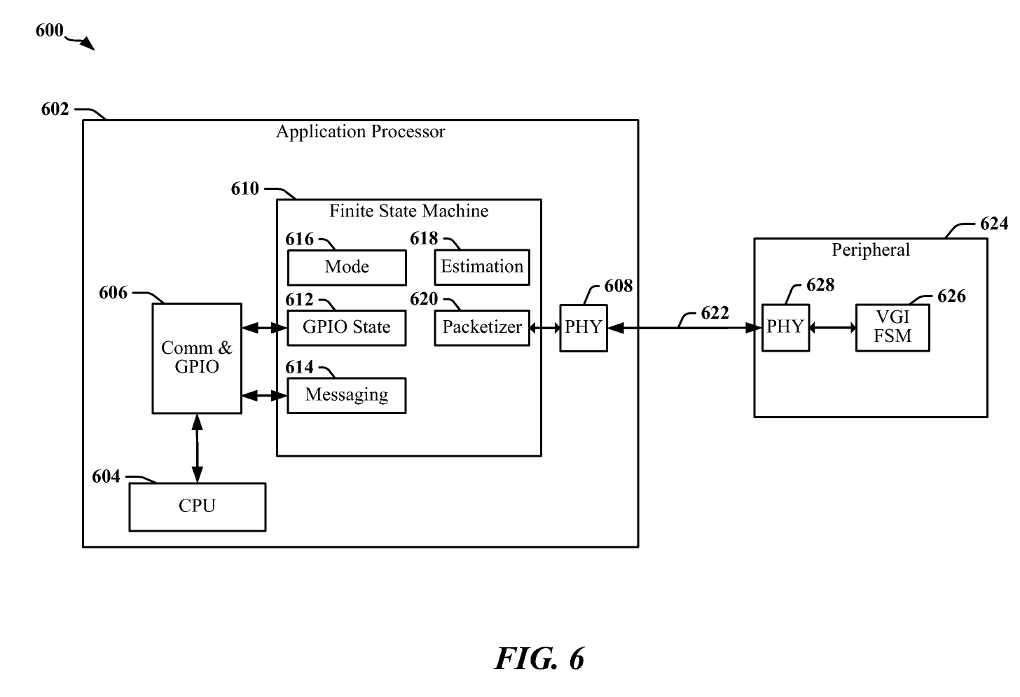

FIG. 6 illustrates an apparatus 600 that is adapted to support Virtual GPIO (VGI or VGMI) in accordance with certain aspects disclosed herein. VGI circuits and techniques can reduce the number of physical pins and connections used to connect an Application Processor 602 with a peripheral device 624. VGI enables a plurality of GPIO signals to be serialized into virtual GPIO signals that can be transmitted over a communication link 622. In one example, virtual GPIO signals may be encoded in packets that are transmitted over a communication link 622 that includes a multi-wire bus, including a serial bus. When the communication link 622 is provided as serial bus, the receiving peripheral device 624 may deserialize received packets and may extract messages and virtual GPIO signals. A VGI FSM 626 in the peripheral device 624 may convert the virtual GPIO signals to physical GPIO signals that can be presented at an internal GPIO interface.

In another example, the communication link 622 may be a provided by a radio frequency transceiver that supports communication using, for example, a Bluetooth protocol, a wireless local area network (WLAN) protocol, a cellular wide area network, and/or another communication protocol. Messages and virtual GPIO signals may be encoded in packets, frames, subframes, or other structures that can be transmitted over the communication link 622, and the receiving peripheral device 624 may extract, deserialize and otherwise process received signaling to obtain the messages and virtual GPIO signals. Upon receipt of messages and/or virtual GPIO signals, the VGI FSM 626 or another component of the receiving device may interrupt its host processor to indicate receipt of messages and/or any changes in in GPIO signals.

In an example in which the communication link 622 is provided as a serial bus, messages and/or virtual GPIO signals may be transmitted in packets configured for an I2C, I3C, RFFE, or another standardized serial interface. In the illustrated example, VGI techniques are employed to accommodate I/O bridging between an Application Processor 602 and a peripheral device 624. The Application Processor 602 may be implemented as an ASIC, SoC, or some combination of devices. The Application Processor 602 includes a processor (central processing unit or CPU 604) that generates messages and GPIO associated with one or more communications channels 606. GPIO signals and messages produced by the communications channels 606 may be monitored by respective monitoring circuits 612, 614 in a VGI FSM 626. In some examples, a GPIO monitoring circuit 612 may be adapted to produce virtual GPIO signals representative of the state of physical GPIO signals and/or changes in the state of the physical GPIO signals. In some examples, other circuits are provided to produce the virtual GPIO signals representative of the state of physical GPIO signals and/or changes in the state of the physical GPIO signals.

An estimation circuit 618 may be configured to estimate latency information for the GPIO signals and messages, and may select a protocol, and/or a mode of communication for the communication link 622 that optimizes the latency for encoding and transmitting the GPIO signals and messages. The estimation circuit 618 may maintain protocol and mode information 616 that characterizes certain aspects of the communication link 622 to be considered when selecting the protocol, and/or a mode of communication. The estimation circuit 618 may be further configured to select a packet type for encoding and transmitting the GPIO signals and messages. The estimation circuit 618 may provide configuration information used by a packetizer 620 to encode the GPIO signals and messages. In one example, the configuration information is provided as a command that may be encapsulated in a packet such that the type of packet can be determined at a receiver. The configuration information, which may be a command, may also be provided to physical layer circuits (PHY 608). The PHY 608 may use the configuration information to select a protocol and/or mode of communication for transmitting the associated packet. The PHY 608 may then generate the appropriate signaling to transmit the packet.

The peripheral device 624 may include a VGI FSM 626 that may be configured to process data packets received from the communication link 622. The VGI FSM 626 at the peripheral device 624 may extract messages and may map bit positions in virtual GPIO signals onto physical GPIO pins in the peripheral device 624. In certain embodiments, the communication link 622 is bidirectional, and both the Application Processor 602 and a peripheral device 624 may operate as both transmitter and receiver.

The PHY 608 in the Application Processor 602 and a corresponding PHY 628 in the peripheral device 624 may be configured to establish and operate the communication link 622. The PHY 608 and 628 may be coupled to, or include a transceiver 108 (see FIG. 1). In some examples, the PHY 608 and 628 may support a two-wire interface such as an I2C, I3C, RFFE, or SMBus interface at the Application Processor 602 and peripheral device 624, respectively, and virtual GPIO signals and messages may be encapsulated into a packet transmitted over the communication link 622, which may be a multi-wire serial bus or multi-wire parallel bus for example.

VGI tunneling, as described herein, can be implemented using existing or available protocols configured for operating the communication link 622, and without the full complement of physical GPIO pins. VGI FSMs 610, 626 may handle GPIO signaling without intervention of a processor in the Application Processor 602 and/or in the peripheral device 624. The use of VGI can reduce pin count, power consumption, and latency associated with the communication link 622.

At the receiving device virtual GPIO signals are converted into physical GPIO signals. Certain characteristics of the physical GPIO pins may be configured using the virtual GPIO signals. For example, slew rate, polarity, drive strength, and other related parameters and attributes of the physical GPIO pins may be configured using the virtual GPIO signals. Configuration parameters used to configure the physical GPIO pins may be stored in configuration registers associated with corresponding GPIO pins. These configuration parameters can be addressed using a proprietary or conventional protocol such as I2C, I3C or RFFE. In one example, configuration parameters may be maintained in I3C addressable registers. Certain aspects disclosed herein relate to reducing latencies associated with the transmission of configuration parameters and corresponding addresses (e.g., addresses of registers used to store configuration parameters).

The VGI interface enables transmission of messages and virtual GPIO signals, whereby virtual GPIO signals, messages, or both can be sent in the serial data stream over a wired or wireless communication link 622. In one example, a serial data stream may be transmitted in packets and/or as a sequence of transactions over an I2C, I3C, or RFFE bus. The presence of virtual GPIO data in I2C/I3C frame may be signaled using a special command code to identify the frame as a VGPIO frame. VGPIO frames may be transmitted as broadcast frames or addressed frames in accordance with an I2C or I3C protocol. In some implementations, a serial data stream may be transmitted in a form that resembles a universal asynchronous receiver/transmitter (UART) signaling and messaging protocol, in what may be referred to as a UART_VGI mode of operation. This may also be referred to as a VGI messaging interface or VGMI.

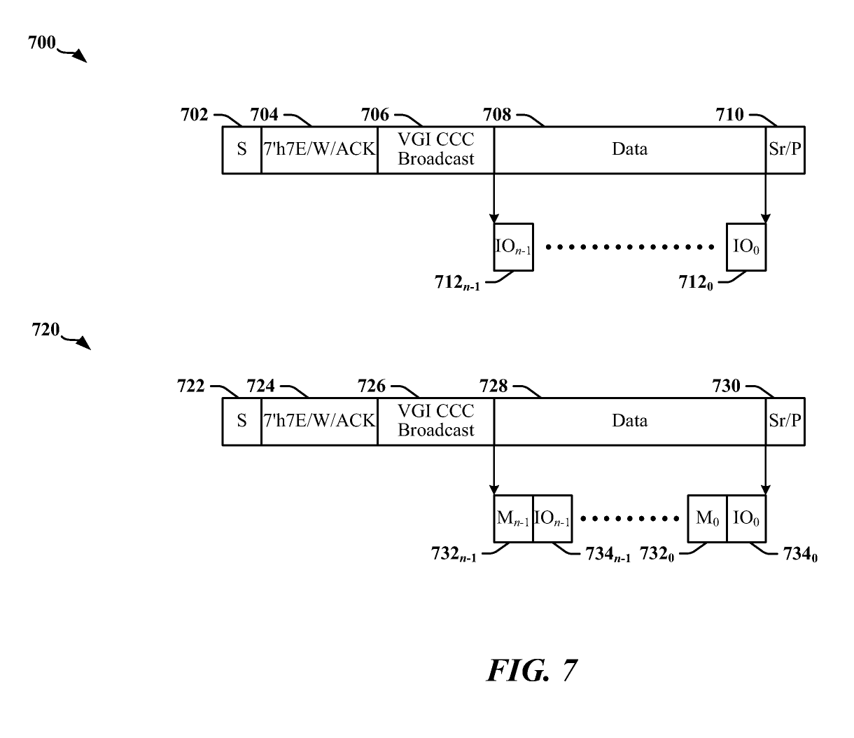

FIG. 7 illustrates examples of VGI broadcast frames 700, 720. In a first example, a broadcast frame 700 commences with a start bit 702 (S) followed by a header 704 in accordance with an I2C or I3C protocol. A VGI broadcast frame may be identified using a VGI broadcast common command code 706. A VGPIO data payload 708 includes a number (n) of virtual GPIO signals 712₀-712ₙ₋₁, ranging from a first virtual GPIO signal 712₀ to an nth virtual GPIO signal 712ₙ₋₁. A VGI FSM may include a mapping table that maps bit positions of virtual GPIO signals in a VGPIO data payload 708 to conventional GPIO pins. The virtual nature of the signaling in the VGPIO data payload 708 can be transparent to processors in the transmitting and receiving devices.

In the second example, a masked VGI broadcast frame 720 may be transmitted by a host device to change the state of one or more GPIO pins without disturbing the state of other GPIO pins. In this example, the I/O signals for one or more devices are masked, while the I/O signals in a targeted device are unmasked. The masked VGI broadcast frame 720 commences with a start bit 722 followed by a header 724. A masked VGI broadcast frame 720 may be identified using a masked VGI broadcast common command code 726. The VGPIO data payload 728 may include I/O signal values 734₀-734ₙ₋₁ and corresponding mask bits 732₀-732ₙ₋₁, ranging from a first mask bit M₀ 732₀ for the first I/O signal (IO₀) to an nth mask bit Mₙ₋₁₇32ₙ₋₁ for the nth I/O signal IOₙ₋.

A stop bit or synchronization bit (Sr/P 710, 730) terminates the broadcast frame 700, 720. A synchronization bit may be transmitted to indicate that an additional VGPIO payload is to be transmitted. In one example, the synchronization bit may be a repeated start bit in an I2C interface.

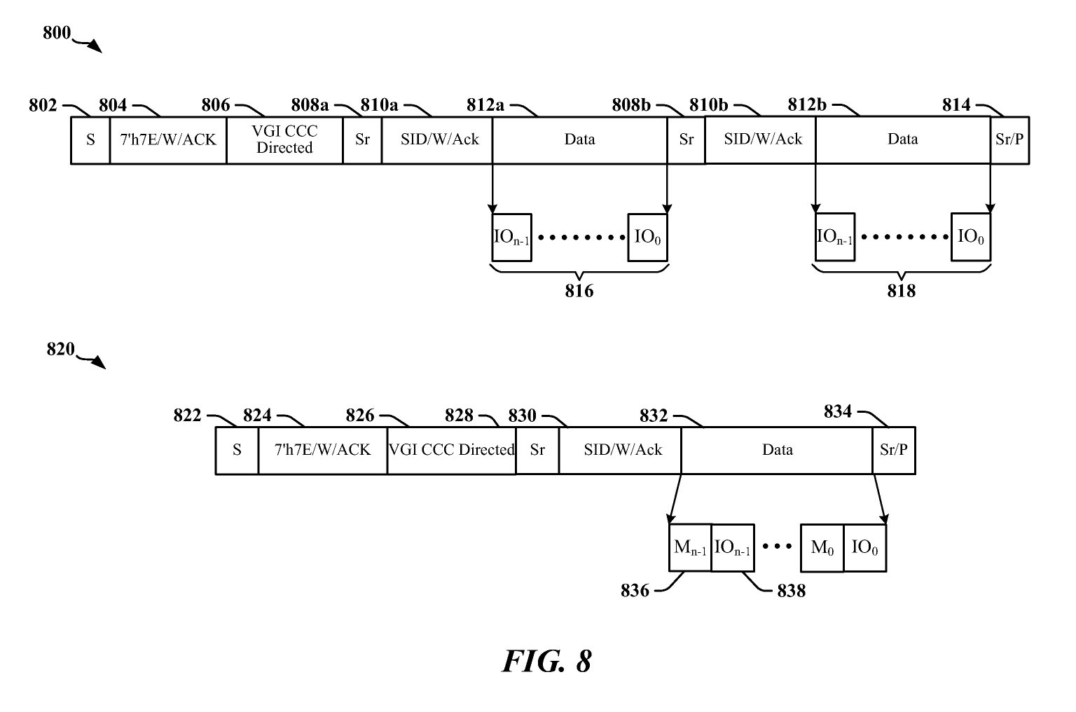

FIG. 8 illustrates examples of VGI directed frames 800, 820. In a first example, VGI directed frames 800 may be addressed to a single peripheral device or, in some instances, to a group of peripheral devices. The first of the VGI directed frames 800 commences with a start bit 802 (S) followed by a header 804 in accordance with an I2C or I3C protocol. A VGI directed frame 800 may be identified using a VGI directed common command code 806. The directed common command code 806 may be followed by a synchronization field 808a (Sr) and an address field 810a that includes a slave identifier to select the addressed device. The directed VGPIO data payload 812a that follows the address field 810a includes values 816 for a set of I/O signals that pertain to the addressed device. VGI directed frames 800 can include additional directed payloads 812b for additional devices. For example, the first directed VGPIO data payload 812a may be followed by a synchronization field 808b and a second address field 810b. In this example, the second directed VGPIO payload 812b includes values 818 for a set of I/O signals that pertain to a second addressed device. The use of VGI directed frames 800 may permit transmission of values for a subset or portion of the I/O signals carried in a broadcast VGPIO frame 700, 720.

In the second example, a masked VGI directed frame 820 may be transmitted by a host device to change the state of one or more GPIO pins without disturbing the state of other GPIO pins in a single peripheral device and without affecting other peripheral devices. In some examples, the I/O signals in one or more devices may be masked, while selected I/O signals in one or more targeted device are unmasked. The masked VGI directed frame 820 commences with a start bit 822 followed by a header 824. A masked VGI directed frame 820 may be identified using a masked VGI directed common command code 826. The masked VGI directed command code 826 may be followed by a synchronization field 828 (Sr) and an address field 830 that includes a slave identifier to select the addressed device. The directed payload 832 that follows includes VGPIO values for a set of I/O signals that pertain to the addressed device. For example, the VGPIO values in the directed data payload 832 may include I/O signal values 838 and corresponding mask bits 836.

A stop bit or synchronization bit (Sr/P 814, 834) terminates the VGI directed frames 800, 820. A synchronization bit may be transmitted to indicate that an additional VGPIO payload is to be transmitted. In one example, the synchronization bit may be a repeated start bit in an I2C interface.

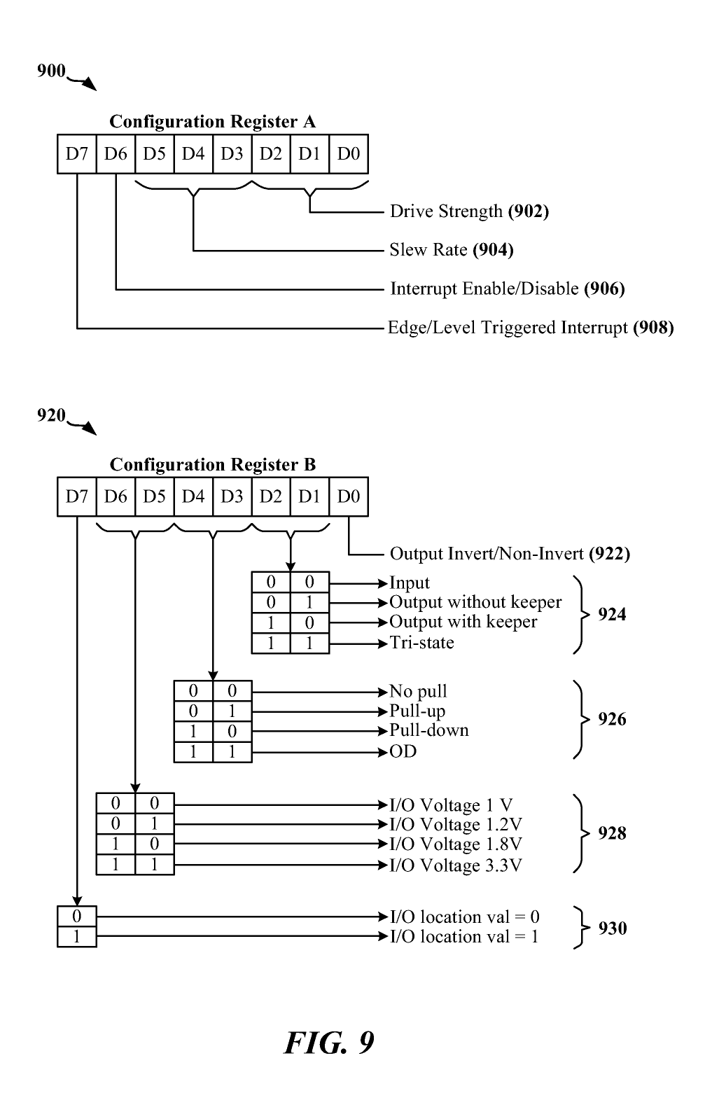

At the receiving device (e.g., the Application Processor 502 and/or peripheral device 504, 506, 508), received virtual GPIO signals are expanded into physical GPIO signal states presented on GPIO pins. The term “pin,” as used herein, may refer to a physical structure such as a pad, pin or other interconnecting element used to couple an IC to a wire, trace, through-hole via, or other suitable physical connector provided on a circuit board, substrate or the like. Each GPIO pin may be associated with one or more configuration registers that store configuration parameters for the GPIO pin. FIG. 9 illustrates configuration registers 900 and 920 that may be associated with a physical pin. Each configuration register 900, 920 is implemented as a one-byte (8 bits) register, where different bits or groups of bits define a characteristic or other features that can be controlled through configuration. In a first example, bits D1-D2 902 control the drive strength for the GPIO pin, bits D3-D5 904 control the slew rate for GPIO pin, bit D6 906 enables interrupts, and bit D7 908 determines whether interrupts are edge-triggered or triggered by voltage-level. In a second example, bit D0 922 selects whether the GPIO pin receives an inverted or non-inverted signal, bits D1-D2 924 define a type of input or output pin, bits D3-D4 926 defines certain characteristics of an undriven pin, bits D5-D6 928 define voltage levels for signaling states, and bit D7 930 controls the binary value for the GPIO pin (i.e., whether GPIO pin carries carry a binary one or zero).

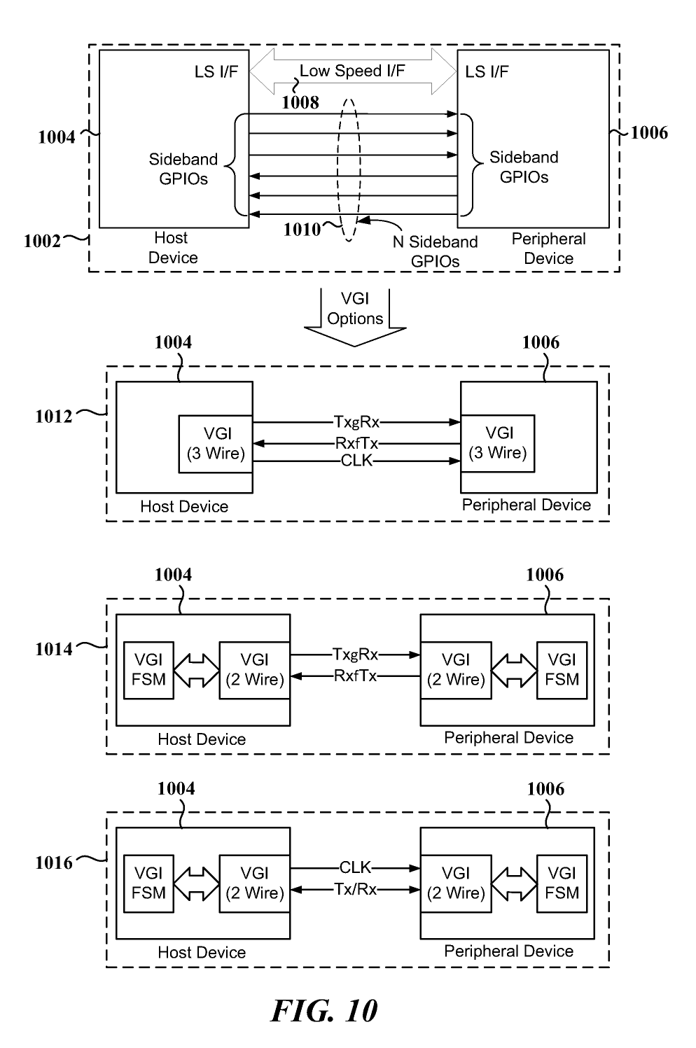

FIG. 10 is a diagram illustrating example VGI implementations. FIG. 10 shows an example configuration 1002 that includes a host device 1004 (e.g., host SoC) coupled to a peripheral device 1006. The host device 1004 and the peripheral device 1006 may transfer signals through a low speed (LS) interface (I/F) 1008 and may transfer an N number of sideband GPIOs 1010. In a first example VGI implementation, as shown in the configuration 1012, a host device and a peripheral device are coupled using a three-wire synchronous full-duplex VGI implementation. In a second example VGI implementation, as shown in the configuration 1014, a host device and a peripheral device are coupled using a two-wire asynchronous full-duplex VGI implementation. In the configuration 1014, the host device and the peripheral device each include a VGI FSM that can make use of a generic physical link, such as an I3C physical link The configuration 1014 may enable NRZ messaging (UART), embedded GPIOs/interrupts, and/or in-band flow-control. In a third example VGI implementation, as shown in the configuration 1016, a host device and a peripheral device are coupled using a two-wire synchronous half-duplex VGI implementation. In the configuration 1016, the host device and the peripheral device each include a VGI FSM that can make use of a generic physical link, such as an I3C physical link

### In-Band Hardware Reset For VGI/VGMI in Point-to-Point Mode

In certain aspects, VGI/VGMI in a point-to-point mode may not include support for in-band hardware reset (IBHR). Consequently, a VGI/VGMI implementation lacking IBHR support may require use of a separate hard reset line to indicate a hardware reset between VGI devices. However, use of the separate hard reset line may be undesirable as its presence increases a package size. Accordingly, there is a need for a VGI/VGMI implementation that supports IBHR for different signaling modes. The present disclosure provides methods for implementing IBHR into 2-wire and 3-wire VGI/VGMI interfaces for a variety of signaling modes.

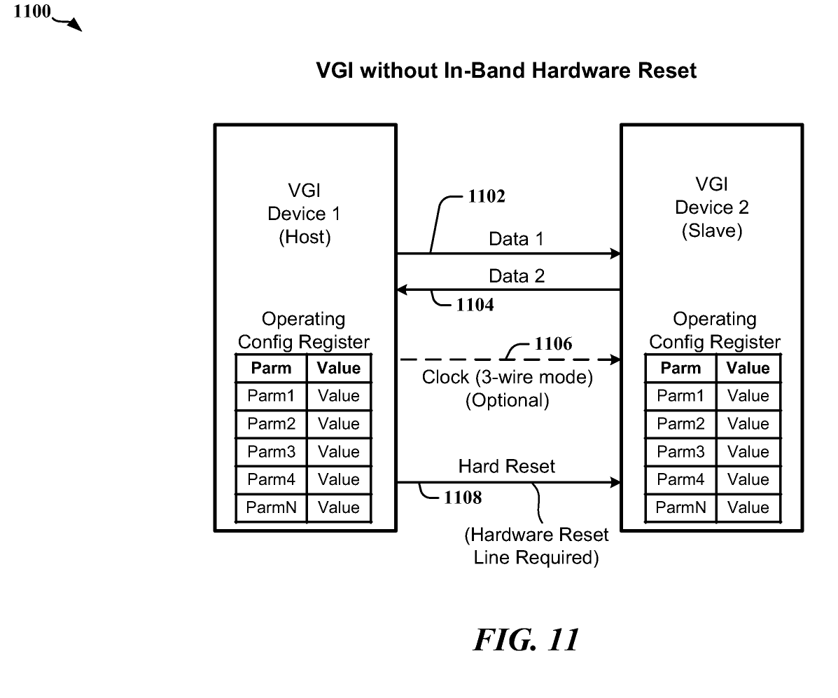

FIG. 11 illustrates a VGI point-to-point configuration 1100 that does not support IBHR. The configuration 1100 may support a 2-wire signaling mode or a 3-wire signaling mode. In the 2-wire signaling mode, a VGI interface may include a first wire 1102 used to communicate first data (Data 1) between a host and slave and a second wire 1104 used to communicate second data (Data 2) between the host and slave. In the 3-wire signaling mode, the VGI interface may further include a third wire 1106 used to communicate a clock signal between the host and slave. When the third wire 1106 is included, the VGI interface is considered to be a 3-wire interface. Moreover, because the configuration 1100 does not support IBHR, a separate hardware reset pin/line 1108 may be required to indicate a hard reset between the host and the slave.

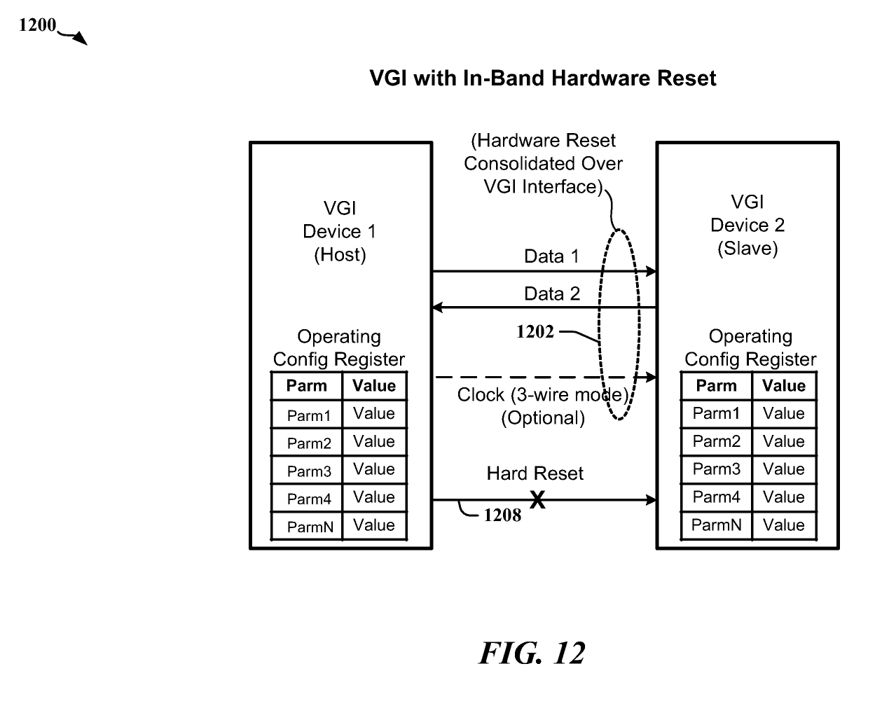

FIG. 12 illustrates a VGI point-to-point configuration 1200 that supports IBHR. In the configuration 1200, the indication of a hardware reset may be consolidated over a VGI interface 1202. Hence, the functionality of a hardware reset pin/line 1208 is absorbed in-band into the VGI interface 1202. The in-band hardware reset function may be implemented into the VGI interface 1202 for different signaling modes (e.g., 2-wire signaling mode, 3-wire signaling mode, etc.). Once implemented, the hardware reset pin/line 1208 is no longer necessary since the hardware reset function is moved to the VGI interface 1202 itself.

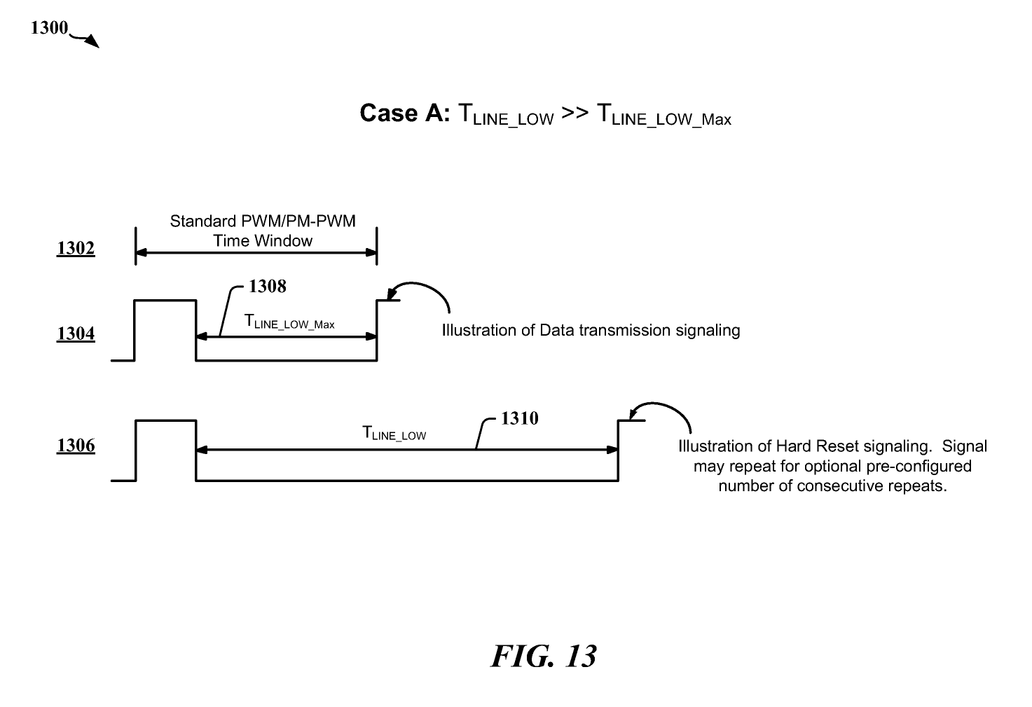

FIG. 13 is a diagram 1300 illustrating a technique for implementing IBHR with VGI with respect to a pulse width modulation (PWM)/phase modulated pulse width modulation (PM-PWM) signaling mode. Notably, the PWM/PM-PWM signaling mode is a 2-wire signaling scheme, and therefore, does not make use of a clock line. Accordingly, hard reset signaling may be based on a configurable time period for which a logic state of a data line remains at 0 (low logic state). In particular, FIG. 13 illustrates a technique for signaling a hard reset based on holding the logic state of the data line at 0 for a time much greater than an ideal maximum time period for holding the logic state at 0 Case A: T_{LINE}_{_}_{LOW}>>T_{LINE}_{_}_{LOW}_{_}Max).

In other aspects of the disclosure, hard reset signaling may be based on a configurable time period for which the logic state of the data line remains at 1 (high logic state). In particular, the technique for signaling the hard reset may be based on holding the logic state of the data line at 1 for a time much greater than an ideal maximum time period for holding the logic state at 1 (T_{LINE}_{_}_{HIGH}>>T_{LINE}_{_}_{HIGH}_{_}_{Max}). As such, the technique described below related to hard reset signaling based on holding the data line at 0 (low logic state) may also apply to hard reset signaling based on holding the data line at 1 (high logic state).

Referring to FIG. 13, a PWM/PM-PWM pulse 1304 is shown. Whether in the PWM mode or the PM-PWM mode, although a phase of the pulse 1304 may change, a timing behavior of the pulse 1304 will not change. As seen, a logic state of a data line remains low most of the time. That is, a data value of 0 is mostly transmitted on the data line. Accordingly, this signaling characteristic may be used to indicate a hard reset, as will be explained below. Notably, according to some aspects, when the pulse 1304 has a high logic state (logic state 1) but has a length less than half a period, the pulse 1304 may be considered to have a logic state 0. However, if the pulse 1304 has the high logic state (logic state 1) and has a length more than half the period, the pulse 1304 may be considered to have the logic state 1.

Also in FIG. 13, a standard PWM/PM-PWM time window 1302 is shown. The time window 1302 defines a standard period for the pulse 1304 to move from a high logic state to a low logic state and back to a high logic state. Accordingly, based on knowing the timing behavior of the pulse 1304 (e.g., knowing how long the pulse 1304 will remain in the high logic state), an ideal T_{LINE}_{_}_{LOW}_{_}_{Max} 1308 may be determined. T_{LINE}_{_}_{LOW}_{_}_{Max} 1308 may represent an ideal maximum time period for when the logic state of the pulse 1304 is 0 since it occupies a maximum portion of the time window 1302 at the low logic state that is not occupied by the pulse 1304 at the high logic state.

In an aspect of the disclosure, as shown via pulse 1306, a period of a pulse's low logic state (T_{LINE}_{_}_{LOW} 1310) may be extended to an amount longer than ideal, e.g., longer than T_{LINE}_{_}_{LOW}_{_}_{Max} 1308, to indicate a hard reset. Thus, when a receiver (e.g., slave device) detects a logic value of 0 for a period longer than T_{LINE}_{_}_{LOW}_{_}_{Max} 1308, the receiver will interpret the signal as a hard reset signal and act accordingly. In an aspect, T_{LINE}_{_}_{LOW} 1310 may be extended to any configurable length longer than T_{LINE}_{_}_{LOW}_{_}_{Max} 1308 to indicate the hard reset. For example, T_{LINE}_{_}_{LOW} 1310 may be extended to 2*TT_{LINE}_{_}_{LOW}_{_}_{Max} 1308, 3*T_{LINE}_{_}_{LOW}_{_}_{Max} 1308, or any other factor multiplied by T_{LINE}_{_}_{LOW}_{_}_{Max} 1308.

The pulse 1306 may be configured to be transmitted on the data line any number of times, e.g., one time, two times, three times, etc. In an aspect of the disclosure, the hard reset may be indicated by consecutively repeating the pulse 1306 having the extended low logic state (T_{LINE}_{_}_{LOW} 1310) a configurable number of times. For example, the hard reset may be defined to be 3 consecutive repetitions of the pulse 1306. Thus, when a receiver detects the 3 consecutive repetitions of the pulse 1306, the receiver will interpret the signal as a hard reset signal and act accordingly. Consequently, the receiver unambiguously learns that the hard reset is indicated, and any chance of confusion is minimized

In a further aspect of the disclosure, at power-on reset, the two devices (e.g., host and slave) between which the hard reset is communicated may agree to a default number of repetitions required to consider the pulse 1306 a hard reset signal. Hence, both devices will have pre-defined knowledge of how many repetitions will be used to indicate hard reset signaling. In an example, the two devices may agree to a default number of 3 repetitions for the pulse 1306. Thus, when the pulse 1306 having T_{LINE}_{_}_{LOW} 1310>>T_{LINE}_{_}_{LOW}_{_}_{Max} 1308 is repeated 3 consecutive times, then a hard reset is indicated.

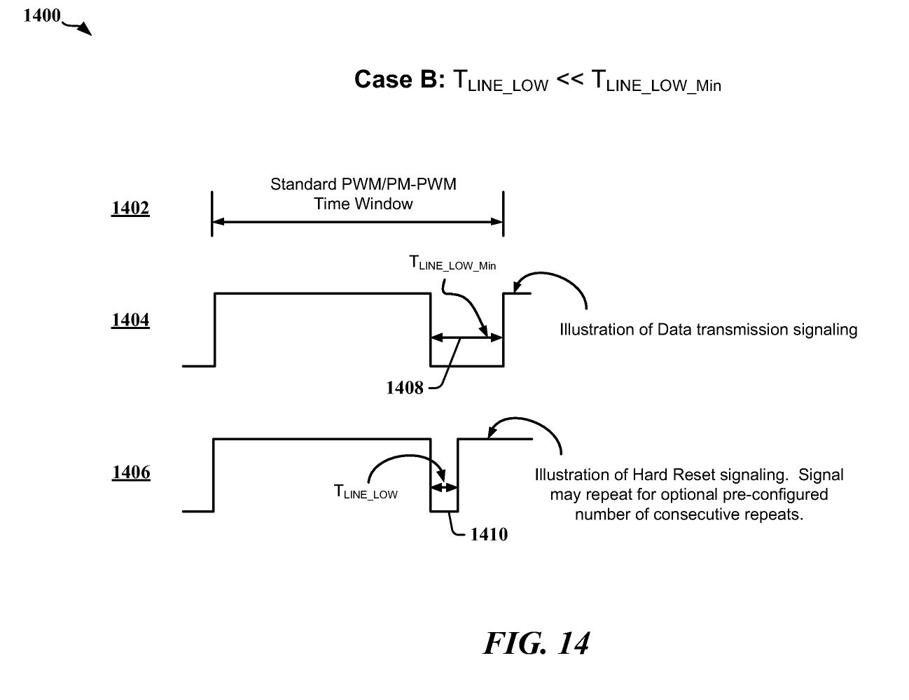

FIG. 14 is a diagram 1400 illustrating another technique for implementing IBHR with VGI with respect to a pulse width modulation (PWM)/phase modulated pulse width modulation (PM-PWM) signaling mode. As noted above, the PWM/PM-PWM signaling mode is a 2-wire signaling scheme, and therefore, does not make use of a clock line. Accordingly, hard reset signaling may be based on a configurable time period for which a logic state of a data line remains at 0 (low logic state). In particular, FIG. 14 illustrates a technique for signaling a hard reset based on holding the logic state of the data line at 0 for a time much less than an ideal minimum time period for holding the logic state at 0 (Case B: T_{LINE}_{_}_{LOW}<<T_{LINE}_{_}_{LOW}_{_}_{Min}).

As noted above, hard reset signaling may be also be based on a configurable time period for which the logic state of the data line remains at 1 (high logic state). In particular, the technique for signaling the hard reset may be based on holding the logic state of the data line at 1 for a time much less than an ideal minimum time period for holding the logic state at 1 (T_{LINE}_{_}_{HIGH}<<T_{LINE}_{_}_{HIGH}_{_}_{Min}). As such, the technique described below related to hard reset signaling based on holding the data line at 0 (low logic state) may also apply to hard reset signaling based on holding the data line at 1 (high logic state).

Referring to FIG. 14, a PWM/PM-PWM pulse 1404 is shown. Whether in the PWM mode or the PM-PWM mode, although a phase of the pulse 1404 may change, a timing behavior of the pulse 1404 will not change. As seen, a logic state of a data line remains high most of the time. That is, a data value of 1 is mostly transmitted on the data line. Accordingly, this signaling characteristic may be used to indicate a hard reset, as will be explained below.

Also in FIG. 14, a standard PWM/PM-PWM time window 1402 is shown. The time window 1402 defines a standard period for the pulse 1404 to move from a high logic state to a low logic state and back to a high logic state. Accordingly, based on knowing the timing behavior of the pulse 1404 (e.g., knowing how long the pulse 1404 will remain in the high logic state), an ideal T_{LINE}_{_}_{LOW}_{_}_{Min} 1408 may be determined. T_{LINE}_{_}_{LOW}_{_}_{Min} 1408 may represent a minimum time period for when the logic state of the pulse 1404 is 0 since it occupies a minimum portion of the time window 1302 at the low logic state that is not occupied by the pulse 1304 at the high logic state.

In an aspect of the disclosure, as shown via pulse 1406, a period of a pulse's low logic state (T_{LINE}_{_}_{LOW} 1410) may be shortened to an amount less than ideal, e.g., less than T_{LINE}_{_}_{LOW}_{_}_{Min} 1408, to indicate a hard reset. Thus, when a receiver (e.g., slave device) detects a logic value of 0 for a period less than T_{LINE}_{_}_{LOW}_{_}_{Min} 1408, the receiver will interpret the signal as a hard reset signal and act accordingly. In an aspect, T_{LINE}_{_}_{LOW} 1410 may be shortened to any configurable length less than T_{LINE}_{_}_{LOW}_{_}_{Min} 1408 to indicate the hard reset. For example, T_{LINE}_{_}_{LOW} 1410 may be shortened to (½)*(T_{LINE}_{_}_{LOW}_{_}_{Min} 1408), (⅓)*(T_{LINE}_{_}_{LOW}_{_}_{Min} 1408), or any other fraction multiplied by T_{LINE}_{_}_{LOW}_{_}_{Min} 1408.

The pulse 1406 may be configured to be transmitted on the data line any number of times, e.g., one time, two times, three times, etc. In an aspect of the disclosure, the hard reset may be indicated by consecutively repeating the pulse 1406 having the shortened low logic state (T_{LINE}_{_}_{LOW} 1410) a configurable number of times. For example, the hard reset may be defined to be 3 consecutive repetitions of the pulse 1406. Thus, when a receiver detects the 3 consecutive repetitions of the pulse 1406, the receiver will interpret the signal as a hard reset signal and act accordingly. Consequently, the receiver unambiguously learns that the hard reset is indicated, and any chance of confusion is minimized

In a further aspect of the disclosure, at power-on reset, the two devices (e.g., host and slave) between which the hard reset is communicated may agree to a default number of repetitions required to consider the pulse 1406 a hard reset signal. Hence, both devices will have pre-defined knowledge of how many repetitions will be used to indicate hard reset signaling. In an example, the two devices may agree to a default number of 3 repetitions for the pulse 1406. Thus, when the pulse 1406 having T_{LINE}_{_}_{LOW} 1410<<T_{LINE}_{_}_{LOW}_{_}_{Min} 1408 is repeated 3 consecutive times, then a hard reset is indicated.

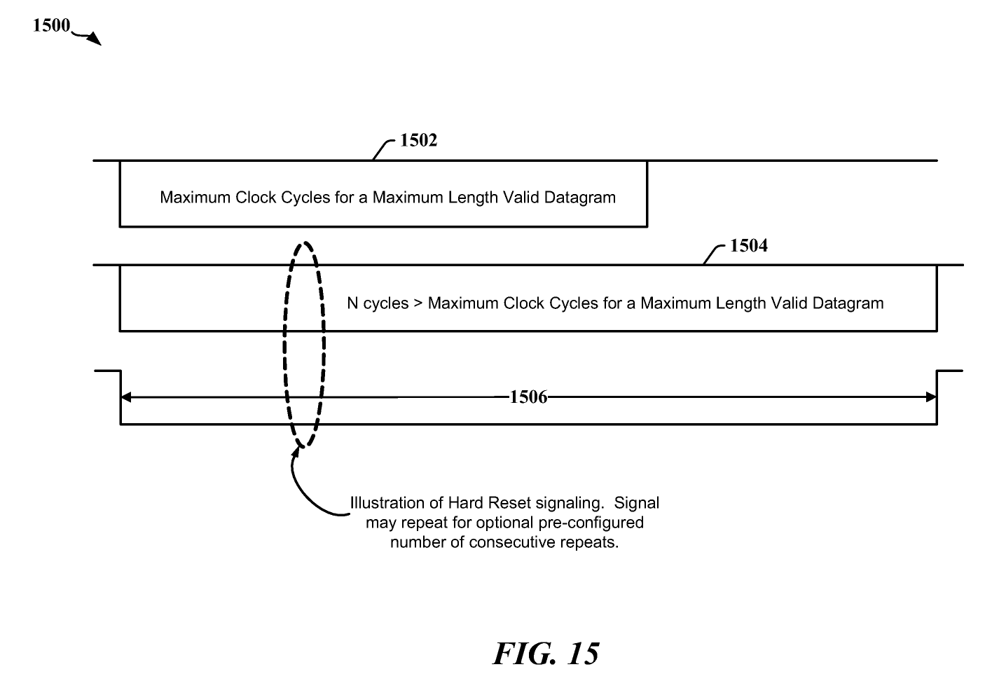

FIG. 15 is a diagram 1500 illustrating a technique for implementing IBHR with VGI with respect to a synchronous UART signaling mode. Notably, the synchronous UART signaling mode is a 3-wire signaling scheme, and therefore, uses two data lines and one clock line to communicate information. Data being input or output via the two data lines is synchronized with a clock line signal.

Referring to FIG. 15, hard reset signaling may be based on a configurable time period for which a logic state of a data line remains at 0 (low logic state). In particular, the hard reset may be based on holding the logic state of a data line at 0 for a time greater than a maximum number of clock cycles for a maximum length valid datagram.

In other aspects of the disclosure, hard reset signaling may be based on a configurable time period for which the logic state of the data line remains at 1 (high logic state). In particular, the hard reset may be based on holding the logic state of the data line at 1 for a time greater than a maximum number of clock cycles for a maximum length valid datagram. As such, the technique described below related to hard reset signaling based on holding the data line at 0 (low logic state) may also apply to hard reset signaling based on holding the data line at 1 (high logic state).

In an aspect, when a first device (e.g., host) desires to indicate a hard reset to a second device (e.g., slave), the first device may determine a maximum number of clock cycles needed for a maximum length valid datagram 1502. Thereafter, the first device may determine N number of clock cycles (N cycles) 1504 greater than the maximum number of clock cycles for a maximum length valid datagram. To indicate the hard reset, the first device may hold the logic state of a data line at 0 for a period 1506 equal to N cycles, which is greater than the maximum number of clock cycles for a maximum length valid datagram. Thus, when the second device detects the logic state of the data line at 0 for the period 1506 equal to N cycles, the second device will interpret the signal as a hard reset signal and act accordingly.

A pulse including the logic state 0 for the period 1506 may be configured to be transmitted on the data line any number of times, e.g., one time, two times, three times, etc. In an aspect of the disclosure, the hard reset may be indicated by consecutively repeating the pulse having the logic state 0 for the period 1506 a configurable number of times. For example, the hard reset may be defined to be 3 consecutive repetitions of the pulse. Thus, when a receiver detects the 3 consecutive repetitions of the pulse having the logic state 0 for the period 1506, the receiver will interpret the signal as a hard reset signal and act accordingly. Consequently, the receiver unambiguously learns that the hard reset is indicated, and any chance of confusion is minimized

In a further aspect of the disclosure, at power-on reset, the two devices (e.g., host and slave) between which the hard reset is communicated may agree to a default number of repetitions required to consider the pulse a hard reset signal. Hence, both devices will have pre-defined knowledge of how many repetitions will be used to indicate hard reset signaling. In an example, the two devices may agree to a default number of 3 repetitions for the pulse. Thus, when the pulse having the logic state 0 for the period 1506 is repeated 3 consecutive times, then a hard reset is indicated.

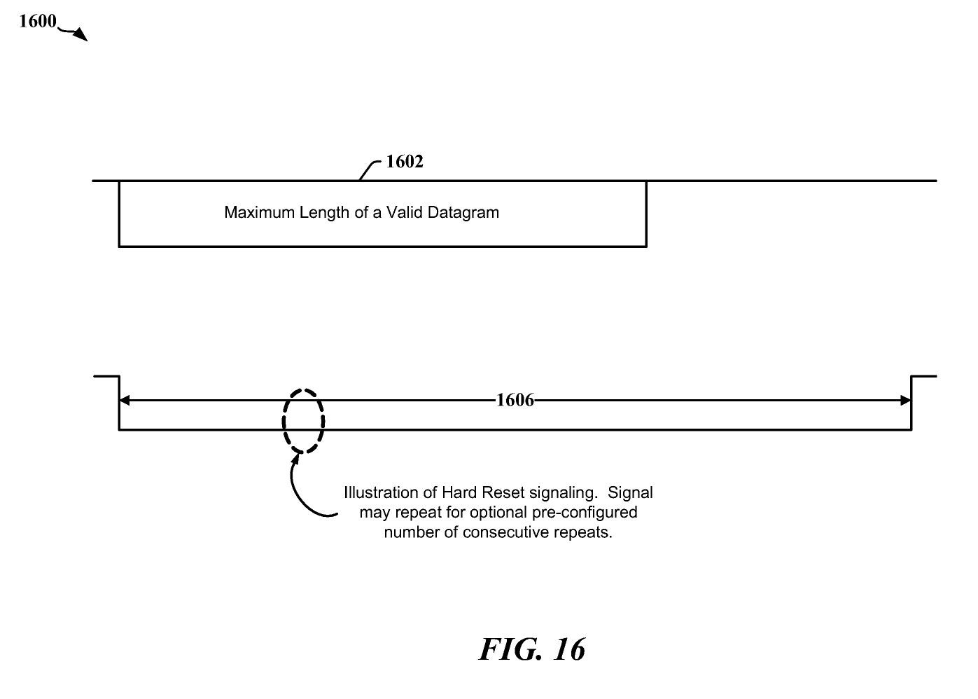

FIG. 16 is a diagram 1600 illustrating a technique for implementing IBHR with VGI with respect to an asynchronous UART signaling mode. Notably, the asynchronous UART signaling mode is a 2-wire signaling scheme, and therefore, uses two data lines and no clock line to communicate information.

Referring to FIG. 16, hard reset signaling may be based on a configurable time period for which a logic state of a data line remains at 0. In particular, the hard reset may be based on holding the logic state of a data line at 0 for a time greater than a maximum length of a valid datagram.

In other aspects of the disclosure, hard reset signaling may be based on a configurable time period for which the logic state of the data line remains at 1 (high logic state). In particular, the hard reset may be based on holding the logic state of the data line at 1 for a time greater than a maximum length of a valid datagram. As such, the technique described below related to hard reset signaling based on holding the data line at 0 (low logic state) may also apply to hard reset signaling based on holding the data line at 1 (high logic state).

In an aspect, when a first device (e.g., host) desires to indicate a hard reset to a second device (e.g., slave), the first device may determine a maximum length of a valid datagram 1602. Thereafter, to indicate the hard reset, the first device may hold the logic state of a data line at 0 for a period 1606, which is greater than the maximum length of the valid datagram. Thus, when the second device detects the logic state of the data line at 0 for the period 1606, the second device will interpret the signal as a hard reset signal and act accordingly.

A pulse including the logic state 0 for the period 1606 may be configured to be transmitted on the data line any number of times, e.g., one time, two times, three times, etc. In an aspect of the disclosure, the hard reset may be indicated by consecutively repeating the pulse having the logic state 0 for the period 1606 a configurable number of times. For example, the hard reset may be defined to be 3 consecutive repetitions of the pulse. Thus, when a receiver detects the 3 consecutive repetitions of the pulse having the logic state 0 for the period 1606, the receiver will interpret the signal as a hard reset signal and act accordingly. Consequently, the receiver unambiguously learns that the hard reset is indicated, and any chance of confusion is minimized

In a further aspect of the disclosure, at power-on reset, the two devices (e.g., host and slave) between which the hard reset is communicated may agree to a default number of repetitions required to consider the pulse a hard reset signal. Hence, both devices will have pre-defined knowledge of how many repetitions will be used to indicate hard reset signaling. In an example, the two devices may agree to a default number of 3 repetitions for the pulse. Thus, when the pulse having the logic state 0 for the period 1606 is repeated 3 consecutive times, then a hard reset is indicated.

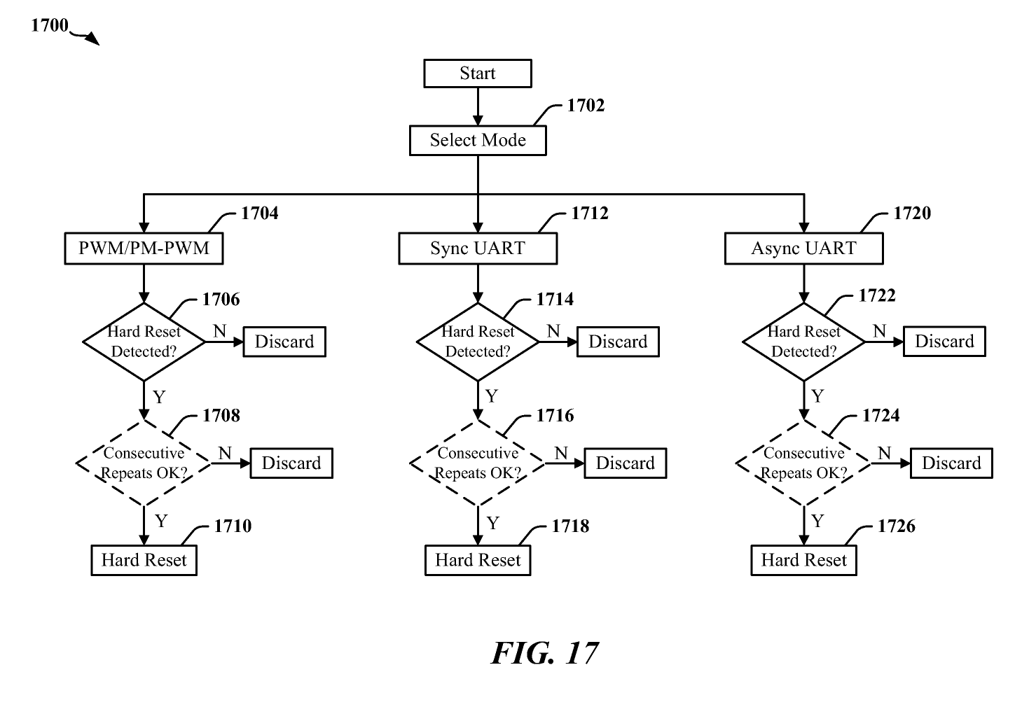

FIG. 17 illustrates a method 1700 for receiving in-band hardware reset (IBHR) signaling according to some aspects of the present disclosure.

At 1702, a device may select a signaling mode. For example, the device may select between a PWM/PM-PWM signaling mode 1704, a synchronous UART signaling mode 1712, and an asynchronous UART signaling mode 1720.

If the PWM/PM-PWM signaling mode 1704 is selected, at 1706, the device may detect whether a pulse having a hard reset signal is received. For example, the device may detect whether a pulse having T_{LINE}_{_}_{LOW}>>T_{LINE}_{_}_{LOW}_{_}_{Max} (or T_{LINE}_{_}_{HIGH}>>T_{LINE}_{_}_{HIGH}_{_}_{Max}) is received, or a pulse having T_{LINE}_{_}_{LOW} <<T_{LINE}_{_}_{LOW}_{_}_{Min} (or T_{LINE}_{_}_{HIGH}<<T_{LINE}_{_}_{HIGH}_{_}_{Min}) is received. If not, the device may discard the pulse as not indicating a hard reset.

If the pulse having the hard reset signal is received, at 1708, the device may optionally determine if the pulse is received a requisite consecutive number of times. If the pulse having the hard reset signal is not received the requisite consecutive number of times, the device may discard the pulse as not indicating the hard reset.

At 1710, if the condition at 1706 and the optional condition at 1708 is satisfied, the device interprets the pulse as indicating the hard reset and performs the hard reset accordingly.

If the synchronous UART signaling mode 1712 is selected, at 1714, the device may detect whether a pulse having a hard reset signal is received. For example, the device may detect whether a pulse having a logic state 0 (or logic state 1) for a period equal to N cycles greater than a maximum number of clock cycles for a maximum length valid datagram is received. If not, the device may discard the pulse as not indicating a hard reset.

If the pulse having the hard reset signal is received, at 1716, the device may optionally determine if the pulse is received a requisite consecutive number of times. If the pulse having the hard reset signal is not received the requisite consecutive number of times, the device may discard the pulse as not indicating the hard reset.

At 1718, if the condition at 1714 and the optional condition at 1716 is satisfied, the device interprets the pulse as indicating the hard reset and performs the hard reset accordingly.

If the asynchronous UART signaling mode 1720 is selected, at 1722, the device may detect whether a pulse having a hard reset signal is received. For example, the device may detect whether a pulse having a logic state 0 (or logic state 1) for a period greater than a maximum length of a valid datagram is received. If not, the device may discard the pulse as not indicating a hard reset.

If the pulse having the hard reset signal is received, at 1724, the device may optionally determine if the pulse is received a requisite consecutive number of times. If the pulse having the hard reset signal is not received the requisite consecutive number of times, the device may discard the pulse as not indicating the hard reset.

At 1726, if the condition at 1722 and the optional condition at 1724 is satisfied, the device interprets the pulse as indicating the hard reset and performs the hard reset accordingly.

### Examples of Methods and Processing Circuits

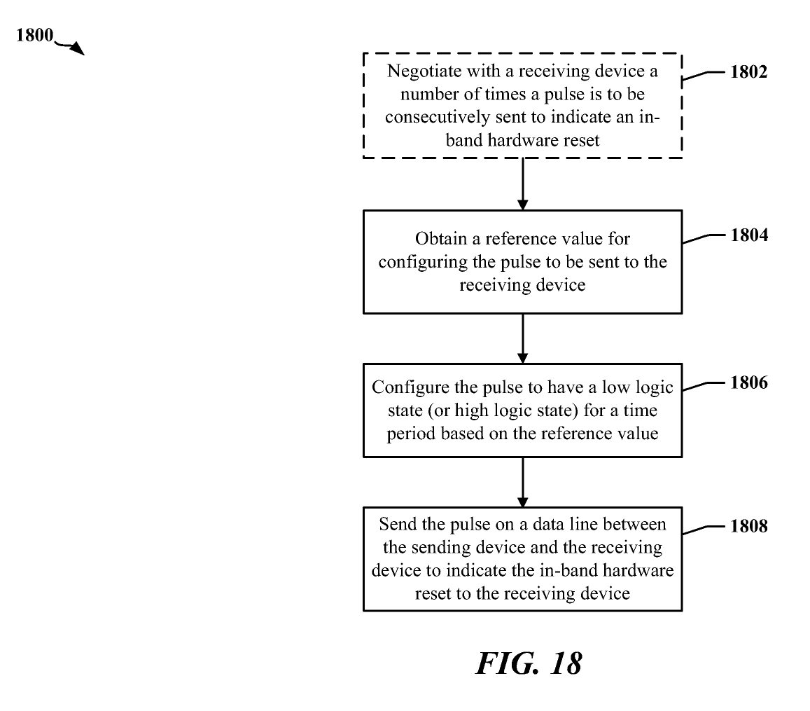

FIG. 18 is a flowchart 1800 of a method that may be performed at a sending device (e.g., host) for signaling an in-band hardware reset to a receiving device (e.g., slave).

At block 1804, the sending device may obtain a reference value for configuring a pulse to be sent to the receiving device. At block 1806, the sending device may configure the pulse to have a logic state (low logic state or high logic state) for a time period based on the reference value.

In an aspect, the reference value may be an ideal maximum time period for the pulse to have the logic state (see 1308 of FIG. 13). Accordingly, the pulse may be configured to have the logic state for the time period that is greater than the ideal maximum time period (see 1310 of FIG. 13).

In a further aspect, the reference value may be an ideal minimum time period for the pulse to have the logic state (see 1408 of FIG. 14). Accordingly, the pulse may be configured to have the logic state for the time period that is less than the ideal minimum time period (see 1410 of FIG. 14).

In another aspect, the reference value may be a maximum number of clock cycles for a maximum length valid datagram (see 1502 of FIG. 15). Accordingly, the pulse may be configured to have the logic state for the time period equivalent to a number of clock cycles greater than the maximum number of clock cycles for the maximum length valid datagram (see 1504 and 1506 of FIG. 15).

In yet another aspect, the reference value may be a maximum length of a valid datagram (see 1602 of FIG. 16). Accordingly, the pulse may be configured to have the logic state for the time period that is greater than the maximum length of the valid datagram (see 1606 of FIG. 16).

At block 1808, the sending device may send the pulse on a data line between the sending device and the receiving device to indicate the in-band hardware reset to the receiving device. In an aspect, the pulse may be sent to the receiving device a consecutive number of times to indicate the in-band hardware reset. As such, at block 1802, prior to obtaining the reference value (block 1804), the sending device may optionally negotiate with the receiving device the number of times the pulse is to be consecutively sent to indicate the in-band hardware reset.

In some implementations, the pulse may be sent to the receiving device in accordance with a standards-defined protocol that controls transmissions over a shared communication link For example, the shared communication link may include a serial bus operated in accordance with an I3C, RFFE, SPMI or other protocol defined by the MIPI Alliance.

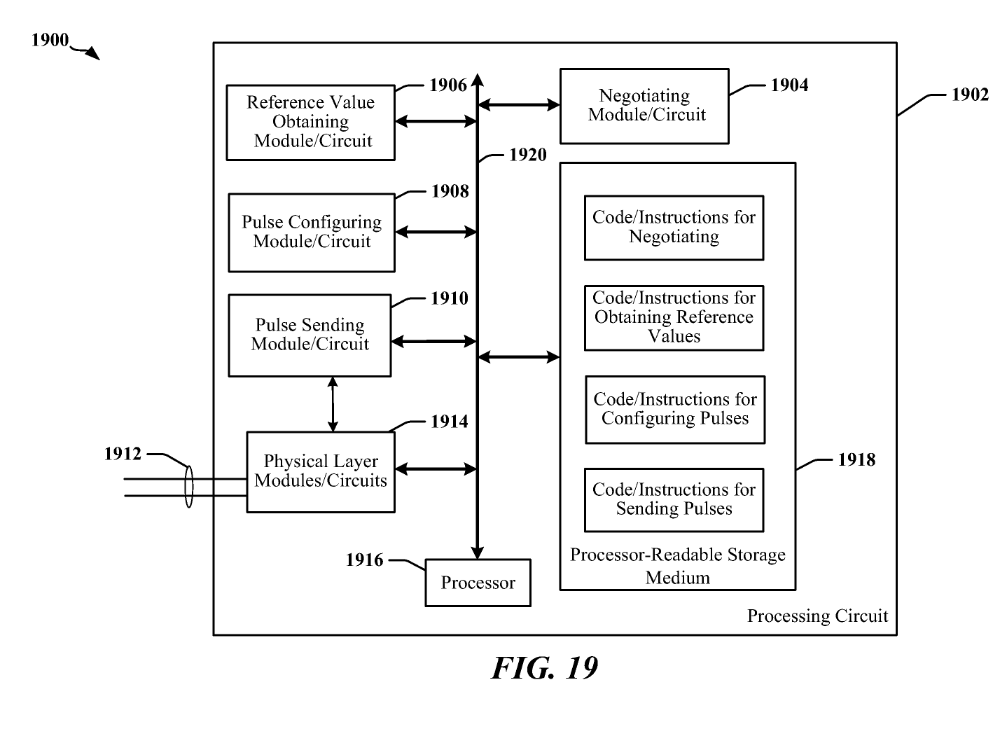

FIG. 19 is a diagram illustrating an example of a hardware implementation for an apparatus 1900 employing a processing circuit 1902. The apparatus may implement a bridging circuit in accordance with certain aspects disclosed herein. The processing circuit typically has a controller or processor 1916 that may include one or more microprocessors, microcontrollers, digital signal processors, sequencers and/or state machines. The processing circuit 1902 may be implemented with a bus architecture, represented generally by the bus 1920. The bus 1920 may include any number of interconnecting buses and bridges depending on the specific application of the processing circuit 1902 and the overall design constraints. The bus 1920 links together various circuits including one or more processors and/or hardware modules, represented by the controller or processor 1916, the modules or circuits 1904, 1906, 1908, and 1910 and the processor-readable storage medium 1918. One or more physical layer circuits and/or modules 1914 may be provided to support communications over a communication link implemented using a multi-wire bus 1912 or other communication structure. The bus 1920 may also link various other circuits such as timing sources, peripherals, voltage regulators, and power management circuits, which are well known in the art, and therefore, will not be described any further.

The processor 1916 is responsible for general processing, including the execution of software, code and/or instructions stored on the processor-readable storage medium 1918. The processor-readable storage medium may include a non-transitory storage medium. The software, when executed by the processor 1916, causes the processing circuit 1902 to perform the various functions described supra (e.g., the functions described with respect to FIG. 18) for any particular apparatus. The processor-readable storage medium may be used for storing data that is manipulated by the processor 1916 when executing software. The processing circuit 1902 further includes at least one of the modules 1904, 1906, 1908, and 1910. The modules 1904, 1906, 1908 and 1910 may be software modules running in the processor 1916, resident/stored in the processor-readable storage medium 1918, one or more hardware modules coupled to the processor 1916, or some combination thereof. The modules 1904, 1906, 1908, and 1910 may include microcontroller instructions, state machine configuration parameters, or some combination thereof.

In one configuration, the apparatus 1900 includes modules and/or circuits 1904 configured to negotiate with a receiving device a number of times a pulse is to be consecutively sent to indicate an in-band hardware reset, modules and/or circuits 1906 configured to obtain a reference value for configuring the pulse to be sent to the receiving device, modules and/or circuits 1908 configured to configure the pulse to have a logic state (low logic state or high logic state) for a time period based on the reference value, and modules and/or circuits 1910 configured to send the pulse on a data line between the sending device and the receiving device to indicate the in-band hardware reset to the receiving device.

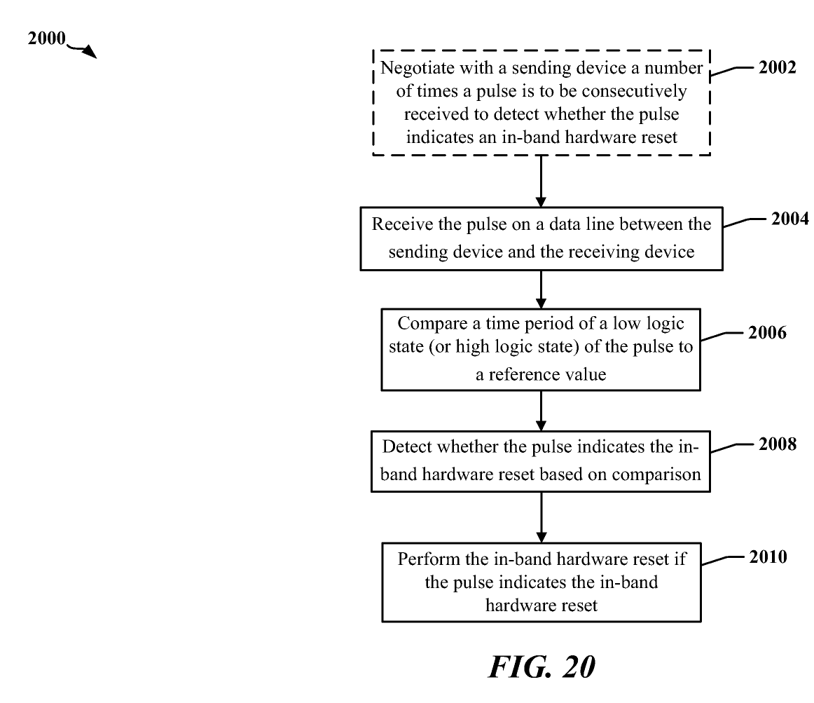

FIG. 20 is a flowchart 2000 of a method that may be performed at a receiving device (e.g., slave) for detecting an in-band hardware reset from a sending device (e.g., host).

At block 2004, the receiving device may receive a pulse on a data line between the sending device and the receiving device.

At block 2006, the receiving device may compare a time period of a logic state (low logic state or high logic state) of the pulse to a reference value.

At block 2008, the receiving device may detect whether the pulse indicates the in-band hardware reset based on the comparison.

At block 2010, the receiving device may perform the in-band hardware reset if the pulse indicates the in-band hardware reset.

In an aspect, the receiving device may further detect whether the pulse indicates the in-band hardware reset based on a consecutive number of times the pulse is received. As such, at block 2002, prior to receiving the pulse (block 2004), the receiving device may optionally negotiate with the sending device the number of times the pulse is to be consecutively received to detect whether the pulse indicates the in-band hardware reset.

In an aspect, the reference value may be an ideal maximum time period for the pulse to have the logic state (see 1308 of FIG. 13). Accordingly, the pulse may be detected to indicate the in-band hardware reset if the time period of the logic state of the pulse is greater than the ideal maximum time period (see 1310 of FIG. 13).

In another aspect, the reference value may be an ideal minimum time period for the pulse to have the logic state (see 1408 of FIG. 14). Accordingly, the pulse may be detected to indicate the in-band hardware reset if the time period of the logic state of the pulse is less than the ideal minimum time period (see 1410 of FIG. 14).

In a further aspect, the reference value may be a maximum number of clock cycles for a maximum length valid datagram (see 1502 of FIG. 15). Accordingly, the pulse may be detected to indicate the in-band hardware reset if the time period of the logic state of the pulse is equivalent to a number of clock cycles greater than the maximum number of clock cycles for the maximum length valid datagram (see 1504 and 1506 of FIG. 15).

In yet a further aspect, the reference value may be a maximum length of a valid datagram (see 1602 of FIG. 16). Accordingly, the pulse may be detected to indicate the in-band hardware reset if the time period of the logic state of the pulse is greater than the maximum length of the valid datagram (see 1606 of FIG. 16).

In some implementations, the pulse may be received from the sending device in accordance with a standards-defined protocol that controls transmissions over a shared communication link For example, the shared communication link may include a serial bus operated in accordance with an I3C, RFFE, SPMI or other protocol defined by the MIPI Alliance.

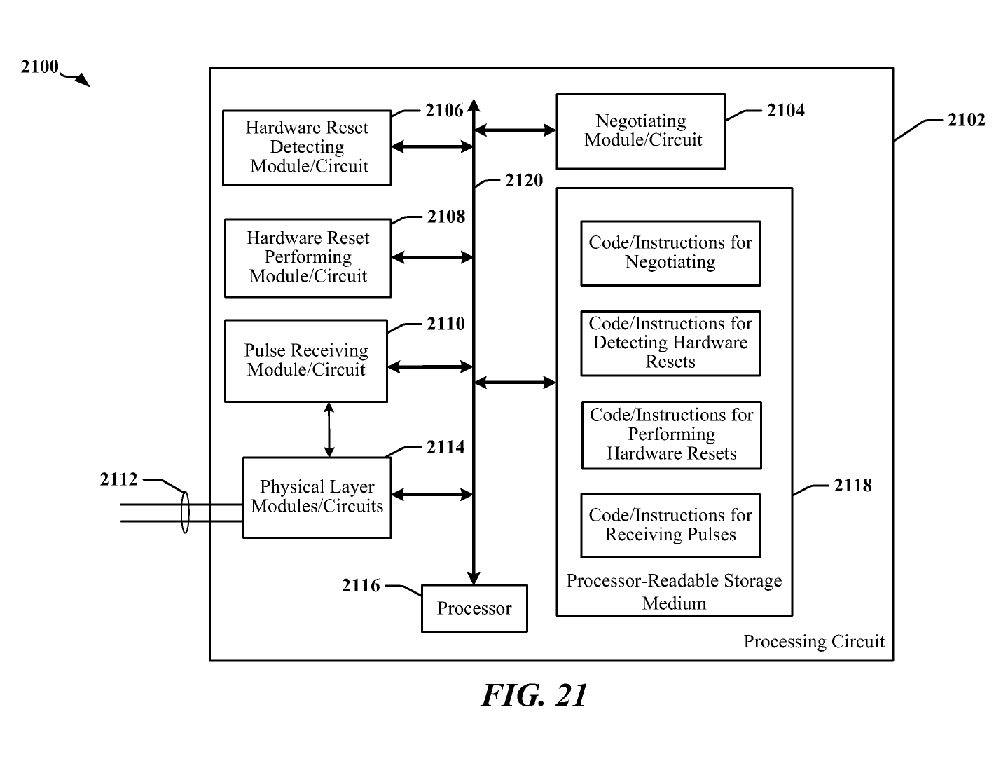

FIG. 21 is a diagram illustrating an example of a hardware implementation for an apparatus 2100 employing a processing circuit 2102. The apparatus may implement a bridging circuit in accordance with certain aspects disclosed herein. The processing circuit typically has a controller or processor 2116 that may include one or more microprocessors, microcontrollers, digital signal processors, sequencers and/or state machines. The processing circuit 2102 may be implemented with a bus architecture, represented generally by the bus 2120. The bus 2120 may include any number of interconnecting buses and bridges depending on the specific application of the processing circuit 2102 and the overall design constraints. The bus 2120 links together various circuits including one or more processors and/or hardware modules, represented by the controller or processor 2116, the modules or circuits 2104, 2106, 2108, and 2110 and the processor-readable storage medium 2118. One or more physical layer circuits and/or modules 2114 may be provided to support communications over a communication link implemented using a multi-wire bus 2112 or other communication structure. The bus 2120 may also link various other circuits such as timing sources, peripherals, voltage regulators, and power management circuits, which are well known in the art, and therefore, will not be described any further.

The processor 2116 is responsible for general processing, including the execution of software, code and/or instructions stored on the processor-readable storage medium 2118. The processor-readable storage medium may include a non-transitory storage medium. The software, when executed by the processor 2116, causes the processing circuit 2102 to perform the various functions described supra (e.g., the functions described with respect to FIGS. 17 and 20) for any particular apparatus. The processor-readable storage medium may be used for storing data that is manipulated by the processor 2116 when executing software. The processing circuit 2102 further includes at least one of the modules 2104, 2106, 2108, and 2110. The modules 2104, 2106, 2108 and 2110 may be software modules running in the processor 2116, resident/stored in the processor-readable storage medium 2118, one or more hardware modules coupled to the processor 2116, or some combination thereof. The modules 2104, 2106, 2108, and 2110 may include microcontroller instructions, state machine configuration parameters, or some combination thereof.

In one configuration, the apparatus 2100 includes modules and/or circuits 2104 configured to negotiate with a sending device a number of times a pulse is to be consecutively received to detect whether the pulse indicates an in-band hardware reset, modules and/or circuits 2106 configured to compare a time period of a logic state (low logic state or high logic state) of the pulse to a reference value and detect whether the pulse indicates the in-band hardware reset based on the comparison, modules and/or circuits 2108 configured to perform the in-band hardware reset if the pulse indicates the in-band hardware reset, and modules and/or circuits 2110 configured to receive the pulse on a data line between the sending device and the receiving device.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. A method performed at a sending device for signaling an in-band hardware reset to a receiving device, comprising:
obtaining a reference value for configuring a pulse to be sent to the receiving device;
configuring the pulse to have a logic state for a time period based on the reference value; and
sending the pulse on a data line between the sending device and the receiving device to indicate the in-band hardware reset to the receiving device.

2. The method of claim 1, wherein the logic state is a low logic state or a high logic state.

3. The method of claim 1, wherein the pulse is sent to the receiving device a consecutive number of times to indicate the in-band hardware reset.

4. The method of claim 3, further comprising:
negotiating with the receiving device the number of times the pulse is to be consecutively sent to indicate the in-band hardware reset.

5. The method of claim 1, wherein:
the reference value is an ideal maximum time period for the pulse to have the logic state; and
the pulse is configured to have the logic state for the time period that is greater than the ideal maximum time period.

6. The method of claim 1, wherein:
the reference value is an ideal minimum time period for the pulse to have the logic state; and
the pulse is configured to have the logic state for the time period that is less than the ideal minimum time period.

7. The method of claim 1, wherein:
the reference value is a maximum number of clock cycles for a maximum length valid datagram; and
the pulse is configured to have the logic state for the time period equivalent to a number of clock cycles greater than the maximum number of clock cycles for the maximum length valid datagram.

8. The method of claim 1, wherein:
the reference value is a maximum length of a valid datagram; and
the pulse is configured to have the logic state for the time period that is greater than the maximum length of the valid datagram.

9. A sending device for signaling an in-band hardware reset to a receiving device, comprising:
a line interface; and
a processing circuit configured to:
obtain a reference value for configuring a pulse to be sent to the receiving device,
configure the pulse to have a logic state for a time period based on the reference value, and
send the pulse on a data line between the sending device and the receiving device via the line interface to indicate the in-band hardware reset to the receiving device.

10. The sending device of claim 9, wherein the logic state is a low logic state or a high logic state.

11. The sending device of claim 9, wherein the pulse is sent to the receiving device a consecutive number of times to indicate the in-band hardware reset, the processing circuit further configured to:
negotiate with the receiving device the number of times the pulse is to be consecutively sent to indicate the in-band hardware reset.

12. The sending device of claim 9, wherein:
the reference value is an ideal maximum time period for the pulse to have the logic state; and
the pulse is configured to have the logic state for the time period that is greater than the ideal maximum time period.

13. The sending device of claim 9, wherein:
the reference value is an ideal minimum time period for the pulse to have the logic state; and
the pulse is configured to have the logic state for the time period that is less than the ideal minimum time period.

14. The sending device of claim 9, wherein:
the reference value is a maximum number of clock cycles for a maximum length valid datagram; and
the pulse is configured to have the logic state for the time period equivalent to a number of clock cycles greater than the maximum number of clock cycles for the maximum length valid datagram.

15. The sending device of claim 9, wherein:
the reference value is a maximum length of a valid datagram; and
the pulse is configured to have the logic state for the time period that is greater than the maximum length of the valid datagram.

16. A method performed at a receiving device for detecting an in-band hardware reset from a sending device, comprising:
receiving a pulse on a data line between the sending device and the receiving device;
comparing a time period of a logic state of the pulse to a reference value;
detecting whether the pulse indicates the in-band hardware reset based on comparison; and
performing the in-band hardware reset if the pulse indicates the in-band hardware reset.

17. The method of claim 16, wherein the logic state is a low logic state or a high logic state.

18. The method of claim 16, wherein the detecting whether the pulse indicates the in-band hardware reset is further based on a consecutive number of times the pulse is received.

19. The method of claim 18, further comprising:
negotiating with the sending device the number of times the pulse is to be consecutively received to detect whether the pulse indicates the in-band hardware reset.

20. The method of claim 16, wherein:
the reference value is an ideal maximum time period for the pulse to have the logic state; and
the pulse is detected to indicate the in-band hardware reset if the time period of the logic state of the pulse is greater than the ideal maximum time period.

21. The method of claim 16, wherein:
the reference value is an ideal minimum time period for the pulse to have the logic state; and
the pulse is detected to indicate the in-band hardware reset if the time period of the logic state of the pulse is less than the ideal minimum time period.

22. The method of claim 16, wherein:
the reference value is a maximum number of clock cycles for a maximum length valid datagram; and
the pulse is detected to indicate the in-band hardware reset if the time period of the logic state of the pulse is equivalent to a number of clock cycles greater than the maximum number of clock cycles for the maximum length valid datagram.

23. The method of claim 16, wherein:
the reference value is a maximum length of a valid datagram; and
the pulse is detected to indicate the in-band hardware reset if the time period of the logic state of the pulse is greater than the maximum length of the valid datagram.

24. A receiving device for detecting an in-band hardware reset from a sending device, comprising:
a line interface; and
a processing circuit configured to:
receive a pulse on a data line between the sending device and the receiving device via the line interface,
compare a time period of a logic state of the pulse to a reference value, detect whether the pulse indicates the in-band hardware reset based on comparison, and
perform the in-band hardware reset if the pulse indicates the in-band hardware reset.

25. The receiving device of claim 24, wherein the logic state is a low logic state or a high logic state.

26. The receiving device of claim 24, wherein the processing circuit configured to detect whether the pulse indicates the in-band hardware reset is further configured to detect based on a consecutive number of times the pulse is received, the processing circuit further configured to:
negotiate with the sending device the number of times the pulse is to be consecutively received to detect whether the pulse indicates the in-band hardware reset.

27. The receiving device of claim 24, wherein:
the reference value is an ideal maximum time period for the pulse to have the logic state; and
the pulse is detected to indicate the in-band hardware reset if the time period of the logic state of the pulse is greater than the ideal maximum time period.

28. The receiving device of claim 24, wherein:
the reference value is an ideal minimum time period for the pulse to have the logic state; and
the pulse is detected to indicate the in-band hardware reset if the time period of the logic state of the pulse is less than the ideal minimum time period.

29. The receiving device of claim 24, wherein:
the reference value is a maximum number of clock cycles for a maximum length valid datagram; and
the pulse is detected to indicate the in-band hardware reset if the time period of the logic state of the pulse is equivalent to a number of clock cycles greater than the maximum number of clock cycles for the maximum length valid datagram.

30. The receiving device of claim 24, wherein:
the reference value is a maximum length of a valid datagram; and
the pulse is detected to indicate the in-band hardware reset if the time period of the logic state of the pulse is greater than the maximum length of the valid datagram.
